(19) United States
(12) Patent Application Publication
(10) Pub. No.: US 2025/0098725 A1
(43) Pub. Date: Mar. 27, 2025

(54) SYSTEM AND METHOD FOR THREE-DIMENSIONAL FOOD PRINTING

(71) Applicant: BOARD OF TRUSTEES OF THE UNIVERSITY OF ARKANSAS, Little Rock, AR (US)

(72) Inventors: Ali Ubeyitogullari, Fayetteville, AR (US); Safoura Ahmadzadeh, Fayetteville, AR (US); Valentine Barbara Rysenaer, Ghent (BE)

(73) Assignee: BOARD OF TRUSTEES OF THE UNIVERSITY OF ARKANSAS, Little Rock, AR (US)

(21) Appl. No.: 18/730,874

(22) PCT Filed: Jan. 27, 2023
(86) PCT No.: PCT/US2023/061514

§ 371 Date: Jul. 22, 2024

Related U.S. Application Data
(60) Provisional application No. 63/303,584, filed on Jan. 27, 2022.
(60) Provisional application No. 63/359,609, filed on Jul. 8, 2022.
(60) Provisional application No. 63/376,094, filed on Sep. 18, 2022.

(51) Int. Cl. A23P 20/20; A23B 2/92; A23L 29/206; A23P 20/25; A23P 30/20

(52) U.S. Cl. CPC A23P 20/20; A23B 2/92; A23L 29/206; A23P 30/20; A23P 2020/253

(57) ABSTRACT

The invention relates to a three-dimensional food printing system and method for fabricating porous hydrogel particles having small sizes and high porosity. The inventive method first forms a highly consistent biopolymer solution with desired rheological properties. The biopolymer solution is extruded using a 3D food printing system and then freeze-dried into the desired porous hydrogel particles, having a desired particle size, morphological, structural, thermal and textural properties, and crystallinity. The hydrogel particles can then be utilized for targeted delivery systems for bioactive compounds, nutraceuticals, micronutrients, probiotics, and the like, and can also be used in connection with personalized nutrition and medicine plans and programs.

### CROSS-REFERENCE TO RELATED APPLICATIONS

This application claims the benefit of U.S. Provisional Patent Application No. entitled 63/376,094, entitled SYSTEM AND PROCESS FOR ENCAPSULATING LUTEIN IN DUAL-LAYERED STARCH-ETHYL CELLULOSE GELS USING THREE-DIMENSIONAL FOOD PRINTING filed on Sep. 18, 2022, U.S. Provisional Patent Application No. 63/359,609, entitled SYSTEM AND METHOD OF EXTRUSION-BASED THREE-DIMENSIONAL FOOD PRINTING FOR GENERATING HYDROGEL PARTICLES filed on Jul. 8, 2022, and U.S. Provisional Patent Application No. 63/303,584, entitled THREE-DIMENSIONAL FOOD PRINTING SYSTEM AND METHOD FOR FABRICATING POROUS STARCH PARTICLES filed on Jan. 27, 2022, and each of said applications is incorporated by reference in its entirety into this document as if fully set out at this point.

### BACKGROUND OF THE INVENTION

### 1. Field of the Invention

This invention generally relates to a system and method for three-dimensional food printing and, more particularly, a system and method for three-dimensional printing a bioactive compound, a nutraceutical, a micronutrient, a probiotic, or the like encapsulated in food-grade biopolymer-based hydrogels.

### 2. Description of the Related Art

Advanced materials with unique properties, such as nanoporous structures, have received significant attention due to their potential applications in modern high-tech fields, including biotechnology and food industries. Potential advanced applications of porous materials in the food industry include the delivery of bioactive compounds for enhanced bioavailability and intelligent packaging for extending shelf-life. In delivery systems, carriers/encapsulants are generally designed to increase the bioavailability of sensitive bioactive compounds by protecting them from degradation during processing, storage, and digestion. The performance of the carriers strongly depends on their size, shape, surface chemistry, and stability. Also, for food applications, using only food-grade materials as carriers is vital for successfully adopting the delivery method.

Additive manufacturing or three-dimensional (“3D”) printing has been recently adapted to manufacture food products. Additive manufacturing (“AM”) technology was initially devised to fabricate complex 3D objects in a single step. This technology has revolutionized cooking and allowed users to evaluate different combinations of food ingredients. Additive manufacturing technology has the potential to fabricate specific foods to supply individual requirements by regulating their nutrient content. Three-dimensional food printing potentially supports a prototyping instrument to simplify the development of new food products, new devices to reshape the supply chain for customized food products, and personalized diets having particular properties associated with calorie, nutritional, and sensorial demands.

To date, 3D food printing has been employed to create 3D geometric shapes of basic food formulations, such as mashed potato, chocolate, meat paste, cheese, and dough. In addition to creating macroscopic geometric shapes, 3D food printing can precisely control the geometry and composition of foods, enabling the development of visually appealing and nutritionally customized foods. Compared to conventional food production methods, 3D food printing as a bottom-up technique is more flexible, less expensive, and minimizes waste production. Moreover, unique properties (e.g., design, size, composition) previously inaccessible can be obtained by using 3D food printing technology.

Several 3D printing techniques, including selective laser sintering, extrusion-based printing, binder jetting, and inkjet printing, have been implemented for 3D printing foods. Among these printing techniques, extrusion-based printing technology is currently the most widely utilized 3D printing technique for food manufacturing due to the large variety of suitable food inks, flexibility, and high printing speed. Similar principles govern both 3D food printing and conventional additive manufacturing; an object created using computer-aided design (“CAD”) is often constructed layer-by-layer using edible materials in the case of 3D food printing. With high flexibility and precision for food customization and diet personalization, 3D printing has the potential to revolutionize the food industry. Various ingredients can be utilized to develop innovative products that would not be possible using other techniques.

Hydrogels have been investigated as encapsulation media for nutrient and drug delivery in the food, biomedical, bioprocessing, and pharmaceutical industries. For instance, hydrogels have been utilized for the targeted delivery of β-carotene, insulin-transferrin conjugates, and antimicrobial peptides, where bioactive compounds are physically entrapped in the polymeric matrix of the hydrogel, inhibiting the interactions between the encapsulated material and the outer environment. Various food-grade biopolymers generating hydrogels have received attention due to their commercial availability, low cost, biocompatibility, and biodegradability.

Starch has received attention among food-grade biopolymer hydrogels due to its ability to create a 3D open porous structure by gelatinization upon heating. In addition, starch can be incorporated into various food formulations, and it is abundant, nontoxic, inexpensive, and biocompatible. Starch is composed of amylose, a linear polymer of α[1→4] linked D-glucose units, and amylopectin, a branched polymer with α[1→4] and α[1→6] bonds, which readily form a gel network through a three-step process of swelling, gelatinization, and retrogradation. Starch hydrogels have been successfully shown to increase the bioaccessibility of bioactive compounds, such as curcumin and polyphenols. Starch hydrogel microspheres for bioactive compound encapsulation have been conventionally produced using emulsion formulations; however, these emulsification approaches utilize surfactants and a high amount of oil, which are later required to be removed using a solvent extraction method. The use of organic solvents and surfactants, and the need for the additional separation step requiring high energy, limit food and pharmaceutical applications of this conventional approach.

Alginate is another of the most broadly utilized polymeric materials for creating hydrogels for encapsulation purposes. It is a natural polysaccharide generally derived from marine brown algae; however, it can also be produced by a microbial fermentation process. The molecular chain structure of alginate consists of linear binary copolymers, beta-D mannuronic acid (M block), and alpha-L glucuronic acid (G block), combined through 1,4 linkages. Alginate forms hydrogel beads in the presence of divalent cations like calcium. Pectin is another polysaccharide-based polymer present in the cell wall of plants. It consists of D-galacturonic acid units joined in chains through alpha-1,4 glycosidic linkages with different degrees of methyl esters substituents. Similar to alginate, gel formation occurs through cross-linking between pectin and calcium ions.

The pH-responsive characteristic of alginate-pectin (“Al-P”) hydrogel particles distinguishes them from alginate or pectin gels only since neither form a gel upon decreasing the pH. The Al-P hydrogels are expected to undergo a gel-solution transition as the pH rises. Furthermore, Al-P gels provide better encapsulation efficiency, protection, and release than those prepared with alginate or pectin alone. Therefore, there are numerous opportunities for alginate and pectin blends to deliver pH-sensitive drugs/nutrients and microorganisms/cells.

So far, Al-P hydrogel particles have been manufactured using the conventional approach, which entails manufacturing the particles with a peristaltic pump. Although the resulting hydrogel particles generated using a peristaltic pump are generally effective, the flow rate is sensitive to altering differential pressure circumstances. In addition, due to manufacturing and tubing replacement variances, the pump system must be calibrated to obtain acceptable accuracy. In some circumstances, their chemical inertness can be a problem.

By isolating the bioactive compounds from the outer environment, the encapsulant protects during food processing, storage, and gastric digestion. The encapsulation could lead to immobilization, protection, stabilization, controlled release of the bioactive compounds, and/or alter the properties of the final products.

Lipophilic bioactive compounds, with numerous health-promoting activities such as reducing the risk of cancer, diabetes, and cardiovascular disease, have several issues limiting their incorporation into foods. These include temperature sensitivity, limited absorption, chemical degradation, and high oxidation tendency. The other major issue with adding lipophilic bioactive compounds into foods is their low solubility. Emulsion-based systems have been widely used to incorporate lipophilic compounds into food formulations. However, despite their extensive use, the delivery of lipophilic bioactive compounds via emulsions has several disadvantages, including poor thermodynamic stability leading to phase separation, sensitivity to temperature and pH, lipid oxidation, and Ostwald ripening.

Carotenoids are lipophilic bioactive compounds that are unstable and poorly soluble in water. Lutein, a xanthophyll carotenoid taken from yellow and green vegetables, fruits, and marigold petals, is of particular interest because of its ability to reduce inflammation, fight cancer, and prevent atherosclerosis. As it is not synthesized in the human body, lutein must be consumed from dietary sources, but like most carotenoids, it has a low water solubility, poor chemical stability, and bioavailability, which further restrict its use in foods. Specifically, lutein is a chemically unstable bioactive molecule due to its oxygen, light, and heat sensitivity. Several delivery systems (i.e., nanoliposomes, nanocrystals, and solid lipid nanoparticles) have been developed to improve lutein's dispersibility in water and its physicochemical stability during processing and storage. However, the application of these systems is limited due to several disadvantages, including low encapsulation efficiency and capacity, short half-life, and poor stability.

### SUMMARY OF THE INVENTION

Accordingly, it is an object of this invention to provide a three-dimensional food printing system and method for extruding food-grade biopolymer and subsequent freeze-drying to obtain porous hydrogels with appropriate properties, including particle size, porosity, morphological, structural, thermal and textural properties, crystallinity, and degree of gelatinization of the hydrogel carrier particles.

Another object of this invention is to provide a system and method for three-dimensional food printing porous food-grade biopolymer hydrogels that eliminates the need for organic solvents, surfactants, and the additional extraction step to remove oil from the resulting hydrogel particles.

A further object of this invention is to provide an extrusion-based three-dimensional food printing system and method for fabricating porous hydrogels with encapsulated bioactive compounds, nutraceuticals, micronutrients, probiotics, and the like. The inventive system and method protect the bioactive compounds and improve their stability against environmental factors by loading them into three-dimensional hydrogel matrices to enhance their stability during processing, storage, and digestion. Using the inventive system and method, bioactive compounds and live microorganisms/cells can be encapsulated in hydrogel particles without damaging the microorganisms/cells during the printing process.

A yet further object of this invention is to provide a coaxial, extrusion-based 3D printing that combines two different hydrogel printing materials into distinct two-layer prints (i.e., core and shell) to provide improved shape retention and encapsulation of bioactive compounds. The inventive extrusion-based 3D food printing system and method provide high precision and flexibility, where high precision allows for generating carrier particles consistently with high accuracy, and high flexibility allows for developing different shapes/sizes with different material compositions for versatile applications. For example, the system and method disclosed herein can provide fine control over the design and composition of the carriers while enabling the use of various biopolymers simultaneously in different cartridges.

The invention generally relates to a method for fabricating a porous hydrogel. The inventive method includes preparing a bio-ink composition comprising a predetermined concentration of a food-grade biopolymer and extruding the bio-ink composition from a three-dimensional food printing system to form the porous hydrogel.

In an embodiment, the food-grade biopolymer comprises starch, alginate, pectin, chitosan, cellulose, agarose, guar gum, agar, carrageenan, gelatin, dextran, xanthan, or a combination or mixture thereof.

In an embodiment, the extruding step can further include extruding the bio-ink composition from the three-dimensional food printing system at a printing temperature of between about 23° C. to about 95° C. (and any range or value therebetween), and more particularly, between about 23° C. to about 25° C. or between about 55° C. to about 95° C., to form the porous hydrogel.

In an embodiment, the extruding step can further include extruding the bio-ink composition from the three-dimensional food printing system at a printing height of between about 0.4 mm to about 5 mm (and any range or value therebetween), and more particularly, about 2.5 cm, to form the porous hydrogel.

In an embodiment, the extruding step can further include extruding the bio-ink composition from the three-dimensional food printing system at a printing speed of between about 4 mm/s to about 6 mm/s (and any range or value therebetween), and more particularly, about 6 mm/s, to form the porous hydrogel.

In an embodiment, the extruding step can further include extruding the bio-ink composition from the three-dimensional food printing system at a pneumatic pressure of between about 1 psi and about 120 psi (and any range or value therebetween), and more particularly, between about 4 psi and about 25 psi, to form the porous hydrogel.

In an embodiment, the extruding step can further include extruding the bio-ink composition from the three-dimensional food printing system from a nozzle having a predetermined diameter to form the porous hydrogel. The diameter of the nozzle can be between about 0.08 mm to about 1.2 mm (and any range or value therebetween), and more particularly, between about 0.08 mm and about 0.33 mm, between about 0.108 mm and about 0.210 mm, or between about 0.7 mm and about 1.2 mm.

In an embodiment, the nozzle includes a shell matrix solution extruder with a diameter of about 1.2 mm and a core solution extruder with a diameter of about 0.7 mm.

In an embodiment, the method includes freeze-drying the porous hydrogel at a temperature of about −80° C.

In an embodiment, the method includes lyophilizing the porous hydrogel at a condenser temperature of about −108° C. under a vacuum pressure of about 0.015 kPa.

In an embodiment, the preparing step can include preparing an aqueous biopolymer suspension or solution with the biopolymer's predetermined concentration.

In an embodiment, the biopolymer is high amylose corn starch having a concentration between about 10% w/w and about 15% w/w (and any range or value therebetween), and more particularly, about 15% w/w.

In an embodiment, the method also includes heating the biopolymer suspension under high shear conditions, such as heating the biopolymer suspension to about 95° C. for about 20 minutes under high shear conditions of about 4260 rpm.

In an embodiment, the step of preparing the bio-ink composition includes preparing an aqueous alginate-pectin solution having an alginate-pectin ratio of about 80:20.

In an embodiment, the alginate-pectin solution has a total gum concentration of between about 1.8 wt. % and about 2.2 wt. % (and any range or value therebetween).

In an embodiment, the extruding step can further include extruding the bio-ink composition from the three-dimensional food printing system into a calcium chloride solution to form the porous hydrogel.

In an embodiment, the calcium chloride solution has a concentration of about 0.1 M.

In an embodiment, the method can include encapsulating a bioactive compound, a nutraceutical, a micronutrient, a probiotic, or a combination or mixture thereof in the porous hydrogel.

In an embodiment, the method can include the steps of preparing a core bio-ink solution comprising at least a bioactive compound, preparing a shell matrix bio-ink solution comprising a food-grade biopolymer, and then extruding the core bio-ink solution and the shell matrix bio-ink solution from a coaxial extrusion nozzle of the three-dimensional food printing system to form the hydrogel encapsulated with the bioactive compound.

In an embodiment, the bioactive compound is a nutraceutical, micronutrient, probiotic, combination, or mixture thereof.

In an embodiment, the step of preparing the core solution can include the steps of preparing a solvent solution comprising a predetermined concentration of a core polymeric material, adding a predetermined amount of the bioactive compound to the polymeric material solvent solution, and then stirring the bioactive compound-polymeric material solvent solution for about 15 minutes and then resting for about 30 minutes at about 4° C. to form the core bio-ink solution.

In an embodiment, the concentration of the polymeric material is between about 6% to about 10% w/v (and any range or value therebetween), and more particularly, about 10% w/v.

In an embodiment, the amount of the bioactive compound is about 20 mg/1 g of the bioactive compound.

In an embodiment, the bio-ink composition is ethyl cellulose between about 6% to about 10% w/v (and any range or value therebetween), lutein about 20 mg/1 g of ethyl-cellulose, and corn starch between about 9% and about 12% w/w (and any range or value therebetween).

In an embodiment, the bio-ink composition is ethyl cellulose of about 10% w/v, lutein of about 20 mg/1 g of ethyl-cellulose, and corn starch between about 10% and about 11% w/w.

In an embodiment, the extruding step can include the step of coaxially extruding the core bio-ink solution at a temperature of about 25° C. and the shell matrix bio-ink solution at an extrusion temperature between about 55° C. to about 75° C. (and any range or value therebetween), and more particularly, between about 55° C. to about 65° C., from the coaxial nozzle of the three-dimensional food printing system.

In an embodiment, the extruding step can include the step of coaxially extruding the core bio-ink solution at a pressure between about 1 and about 3 psi and the shell matrix bio-ink solution at a pressure between about 40 and 50 psi (and any range or value therebetween) from the coaxial nozzle of the three-dimensional food printing system.

In an embodiment, the method can also include freeze-drying the hydrogel encapsulated with the bioactive compound at a predetermined freeze-drying temperature, such as about −80° C., to form a dual-layered cryogel encapsulated with the bioactive compound.

In an embodiment, the method can also include lyophilizing the hydrogel encapsulated with the bioactive compound at a condenser temperature of about −108° C. under a vacuum pressure of about 0.015 kPa.

The invention also relates to a porous hydrogel fabricated from the process described in one or more of the above-referenced embodiments.

The invention also relates to a targeted delivery system having a hydrogel encapsulated with a bioactive compound, nutraceutical, micronutrient, probiotic, or a combination or mixture thereof fabricated from the process described in one or more of the above-referenced embodiments.

### BRIEF DESCRIPTION OF THE DRAWINGS

The above and other objects and advantages of this invention may be more clearly seen when viewed in conjunction with the accompanying drawings wherein:

FIG. 1A is a schematic diagram of an example of an extrusion-based 3D food printing system in accordance with an illustrative embodiment of the invention disclosed herein.

FIG. 1B is a schematic diagram of an example of a coaxial extrusion-based 3D food printing system in accordance with an illustrative embodiment of the invention disclosed herein.

FIGS. 2A through 2O are photographs of 3D particles produced using starch concentrations of (a) 10% w/w (FIGS. 2A-2E), (b) 12.5% w/w (FIGS. 2F-2J), and (c) 15% w/w (FIGS. 2K-2O).

FIGS. 3A through 3J are FE-SEM images of the surface and cross-section of the 3D-printed starch particles generated using starch concentrations of 10% w/w (FIGS. 3A-3C), 12.5% w/w (FIGS. 3D-3F), and 15% w/w (FIGS. 3G-3I), in addition to high amylose corn starch (HACS) (FIG. 3J).

FIGS. 4A through 4D are graphical representations of the pore size distribution of 3D-printed starch particles produced using starch concentrations of (a) 10% w/w (FIG. 4A), (b) 12.5% w/w (FIG. 4B), (c) 15% w/w (FIG. 4C), and (d) their surface thickness (FIG. 4D).

FIGS. 5A and 5B are graphical representations of the density (FIG. 5A) and porosity (FIG. 5B) of 3D-printed starch particles as a function of starch concentration.

FIG. 6 is ATR-FTIR spectra of HACS and 3D-printed starch particles.

FIG. 7 is XRD patterns of the HACS and 3D-printed starch particles made from inks with 10% w/w, 12.5% w/w, and 15% w/w starch content.

FIG. 8 is DSC profiles of the HACS and 3D-printed starch particles from inks with 10% w/w, 12.5% w/w, and 15% w/w starch content.

FIGS. 9A through 9D are graphical representations of (FIG. 9A) viscosity as a function of shear rate at 95° C.; G′ versus temperature (FIG. 9B1); tan δ versus temperature (FIG. 9B2); stress (FIG. 9C); and frequency dependence of G′ and G″ for starch pastes at various concentrations (FIG. 9D).

FIGS. 10A through 10D are graphical representations of (FIG. 10A) viscosity as a function of shear rate at 25° C.; (FIG. 10B) G′; (FIG. 10C) G″; and (FIG. 10D) tan δ as a function of angular frequency for Al-P solutions at various concentrations in accordance with an illustrative embodiment of the invention disclosed herein.

FIGS. 11A and 11B are graphical representations of the particle size of Al-P hydrogels generated via (FIG. 11A) the conventional and (FIG. 11B) the system and method of extrusion-based three-dimensional food printing disclosed herein. *No Product means it was not possible to form droplets from 2.2 wt. % TGC using the nozzle size of 0.108 mm inner diameter. The nozzle size of 0.337 mm was used for comparison with the literature. Different letters above data points indicate that they are significantly different (p<0.05).

FIGS. 12A and 12B are photographs of Al-P hydrogel particles generated using (FIG. 12A) the conventional and (FIG. 12B) the system and method of extrusion-based three-dimensional food printing disclosed herein. *No product means it was not possible to form droplets from 2.2 wt. % TGC using the nozzle size of 0.108 mm inner diameter via the conventional method.

FIG. 13A through 13C1 are SEM images of freeze-dried Al-P particles. All the particles were formed using the system and method of extrusion-based three-dimensional food printing disclosed herein with a nozzle size of 0.159 mm (TG 1.8 wt. % at 25 μm, FIG. 13A; TG 2.0 wt. % at 25 μm, FIG. 13B; TG 2.2 wt. % at 25 μm, FIG. 13C; TG 1.8 wt. % at 5 μm, FIG. 13A1; TG 2.2 wt. % at 5 μm, FIG. 13B1; TG 2.2 wt. % at 5 μm, FIG. 13C1).

FIG. 14 is XRD patterns of the (a) pectin, (b) alginate, and 3D-printed Al-P particles produced using TGC of (c) 1.8, (d) 2.0, and (e) 2.2 wt. %.

FIG. 15 is ATR-FTIR spectra of the (a) pectin, (b) alginate, and 3D-printed Al-P particles produced using TGC of (c) 1.8, (d) 2.0, and (e) 2.2 wt. %.

FIG. 16 is a 3D model with a spiral cube shape used for 3D printing and lutein encapsulation in accordance with an illustrative embodiment of the invention disclosed herein.

FIGS. 17A, 17B, and 17C are photographic images of 3D-printed gels with a 0.4 mm layer height (LH) (FIG. 17A), 0.7 mm LH (FIG. 17B), and 0.7 mm LH (FIG. 17C) produced in accordance with an illustrative embodiment of the invention disclosed herein.

FIGS. 18A1, 18B1, and 18C1 are microCT images of 3D-printed gels with a 0.4 mm layer height (LH) (FIG. 18A1), 0.7 mm LH (FIG. 18B1), and 0.7 mm LH (FIG. 18C1) produced in accordance with an illustrative embodiment of the invention disclosed herein.

FIG. 19A through FIG. 19R are photographic images of 3D-printed spiral cubes produced using starch(S) concentrations of 9, 10, 11, and 12% (w/w), ethyl-cellulose (EC) concentrations of 6, 8, and 10% (w/v), and at printing temperatures of 55, 65, and 75° C. (S-9/EC-00 (55° C.), FIG. 19A; S-10/EC-00 (55° C.), FIG. 19B; S-11/EC-00 (55° C.), FIG. 19C; S-11/EC-10 (75° C.), FIG. 19D; S-11/EC-10 (65° C.), FIG. 19E; S-11/EC-10 (55° C.), FIG. 19F; S-9/EC-10 (75° C.), FIG. 19G; S-9/EC-10 (65° C.), FIG. 19H; S-9/EC-10 (55° C.), FIG. 19I; S-12/EC-10 (75° C.), FIG. 19J; S-12/EC-10 (65° C.), FIG. 19K; S-12/EC-10 (55° C.), FIG. 19L).

FIG. 20A is a photographic image of the cross-section of the 3D-printed gel (S-10/EC-10 (55° C.)).

FIG. 20B through FIG. 20D are SEM images taken from cross-sections of the 3D-printed (FIG. 20B) dual-layered cryogel with an inner starch section (FIGS. 20C1, 20C2), an outer starch section (FIG. 20D), and a core (EC-lutein) (FIGS. 20E1 and 20E2).

FIGS. 20F and 20G are SEM images of a pure starch cryogel (FIG. 20F) and a pure EC cryogel (FIG. 20G).

FIGS. 21A and 21B are graphical representations illustrating the storage stability of lutein at 25° C. (FIG. 21A) and 50° C. (FIG. 21B). Control crude lutein represents a physical mixture of lutein, EC, and starch.

### DETAILED DESCRIPTION OF THE INVENTION

While this invention is susceptible to embodiment in many different forms, there are shown in the drawings and will herein be described hereinafter in detail some specific embodiments of the invention. It should be understood, however, that the present disclosure is to be considered an exemplification of the principles of the invention and is not intended to limit the invention to the specific embodiments so described.

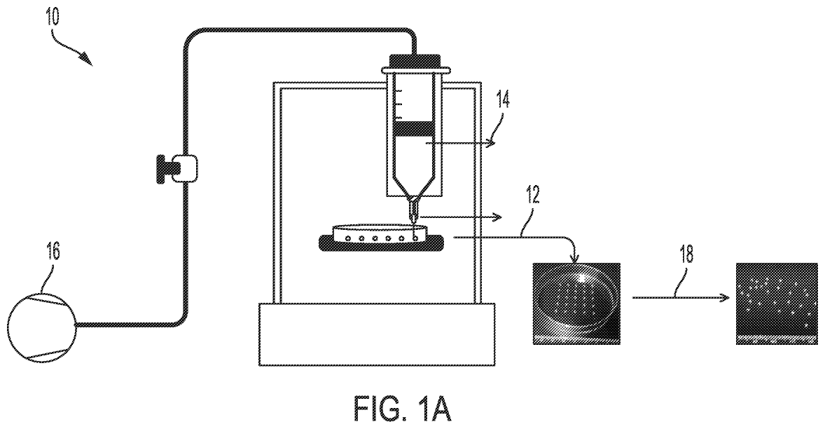

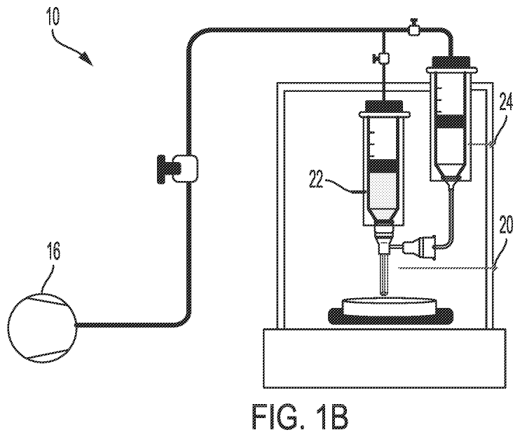

The invention relates to a system and method of extrusion-based three-dimensional food printing for fabricating hydrogel carrier particles, and the inventive extrusion-based 3D printing system and method precisely control and fabricate the size, shape, morphology, and composition of the resulting hydrogel particles. The inventive method first forms a bio-ink composition from a food-grade biopolymer or other biodegradable, hydrophobic polymeric material with desired rheological properties. The biopolymer for generating the hydrogel particles can be starch (e.g., high amylose corn), chitosan, alginate, pectin, cellulose, agarose, guar gum, agar, carrageenan, gelatin, dextran, xanthan, or a combination or mixture thereof, and the biopolymer for forming the bio-ink composition can have a concentration between about 1 to about 15 wt. %. As illustrated in FIG. 1A, the bio-ink composition 14 is extruded using the 3D food printing system 10 having an extrusion nozzle 12 with a predetermined nozzle diameter (e.g., about 0.08 mm to about 1.2 mm), printing pressure 16 (e.g., about 1 psi to about 120 psi), print height (e.g., about 0.4 mm to about 5 cm), printing temperature (e.g., about 23° C. to about 95° C.), and printing speed (e.g., about 4 mm/s to about 6 mm/s) to generate the hydrogel carrier particles.

The 3D-printed hydrogel carrier particles are then lyophilized 18 or freeze-dried under a vacuum for a predetermined amount of time (e.g., about −108° C. to about −80° C. at about 0.015 kPa for at least about 48 h). The 3D food printing method uses extrusion and freeze-drying without the use of organic solvents or surfactants, and since no oil or surfactants are used, the inventive method also does not require an additional extraction step to remove oil from the resulting porous hydrogel carrier particles.

Using the system and method disclosed herein, bioactive compounds and live microorganisms/cells can be encapsulated in the open porous structure of the 3D-printed hydrogel carrier particles without damaging the microorganisms/cells during the printing process. As such, the inventive system and method can fabricate porous, macro- or micro-sized carrier particles for targeted delivery of encapsulated bioactive compounds, nutraceuticals, micronutrients, probiotics, and the like in personalized nutrition and medicine plans and programs.

The system and method disclosed herein accurately control the detailed design and composition of the carrier particles while enabling the use of various polymers simultaneously in different cartridges. The inventive system and process can encapsulate bioactive compounds, nutraceuticals, micronutrients, probiotics, or a combination or mixture thereof in dual-layered bioactive polymer gels using three-dimensional food printing. For example, as illustrated in FIG. 1B, the 3D printing system 10 can have a coaxial nozzle assembly 20 for coaxial extrusion 3D printing to generate lipophilic bioactive compound-loaded (e.g., lutein) hydrogels with an inner flow (core) as bioactive compound-loaded hydrogel 22 (e.g., ethyl cellulose (EC)) and an outer flow (shell) as hydrogel (e.g., corn starch) paste 24. The inventive system and process use 3D printing and porous biopolymers to increase the stability of lipophilic bioactive compounds. The inventive dual-layered hydrogels with the encapsulated lipophilic bioactive compound are 3D printed using predetermined printing parameters, including hydrogel concentration, layer height, printing pressure, and printing temperature.

High amylose corn starch paste is utilized for the outer layer because of its great extrudability and shape stability compared to other starches. Another food-grade biopolymer, EC, is used as a hydrophobic polymeric material in the core layer to encapsulate lutein because EC is non-toxic, biodegradable, and has high mechanical strength. Using extrusion-based 3D printing, the inventive system and process encapsulate the lipophilic bioactive compounds with EC, which provides the rheological properties needed for extrusion.

### EXAMPLES

The extrusion-based 3D food printing system and method are further illustrated by the following examples, which are provided for the purpose of demonstration rather than limitation. In these examples, the parameters of the 3D printing method (i.e., nozzle diameter, printing pressure, and food-grade biopolymer concentration) were optimized for the smallest particle size of 3D-printed hydrogel particles. The effects of nozzle diameter, printing pressure, and biopolymer concentration on particle size, morphological, structural, and thermal properties of the freeze-dried hydrogel particles were investigated in the examples, along with structural integrity and printing accuracy and consistency in determining the optimum printing parameters. In addition, the particle sizes of the hydrogel particles produced using the extrusion-based 3D food printing system and method were compared to those produced using traditional methods.

### Example 1: Three-Dimensional Food Printing System and Method for Fabricating Porous Starch Hydrogel Particles

Extrusion-based 3D food printing was used to fabricate spherical porous starch beads from varying starch concentrations (10, 12.5, and 15%, w/w) and nozzle sizes (0.33, 0.25, 0.15, 0.10, and 0.08 mm). The bead size of starch beads can be optimized by decreasing the nozzle size and increasing the starch concentration. The smallest bead size (˜650 μm) was achieved using a 15% starch concentration with a nozzle size of 0.08 mm. The bulk density and porosity of the 3D-printed beads ranged between 0.14-0.23 g/cm3 and 86-92%, respectively. All the 3D-printed starch beads showed an open porous structure. However, a nonporous layer covering the 3D-printed beads was observed, and its thickness increased as the starch concentration increased, which may provide extra protection in encapsulation applications. Also, the sphericity of the beads increased with increasing the starch concentration. The crystallinity of starch decreased mainly due to the gelatinization process involved prior to and during 3D printing. The chemical structure and thermal properties of the 3D-printed beads were also investigated for their further applications. Starch pastes' viscosity and storage modulus increased with starch concentration, resulting in a better shape fidelity (i.e., spherical shape) at 15% starch concentration. Overall, the inventive 3D food printing method can provide precise control over the shape, size, and composition of the 3D-printed beads. The porous structure of the 3D-printed starch beads enables them to be used for the delivery of bioactive compounds/drugs in the food and pharmaceutical industries.

### Materials.

High amylose corn starch (HACS) with 72% amylose content (Hylon VII) (Ingredion, IL, USA) was used as the raw material to generate particles.

### Preparation of Starch Particles.

To prepare starch particles for extrusion-based 3D food printing, aqueous starch suspensions of three concentrations (10% w/w, 12.5% w/w, and 15% w/w) were made. These starch concentrations were selected based on preliminary 3D food printing experiments. The samples were then heated up to 95° C. under high shear (4260 rpm) using a Thermomix (Vorwerk, CA, USA), and maintained at this temperature for 20 min, and then immediately used as an ink for 3D food printing.

### Preparation of Hydrogel Particles Using 3D Food Printing.

3D food printing was carried out using an Allevi 2 Bioprinter (Allevi, Inc., PA, USA) equipped with two (2) 10 mL extruders. The ink extrusion was empowered by pneumatic pressure (FIG. 1). The starch paste was loaded into a 10 mL cartridge which was then transferred to one of the extruders of the 3D printer previously warmed up to 95° C. The starch hydrogel was then extruded through nozzles with different diameters (i.e., 23, 25, 30, 32, and 34 G corresponding to 0.330, 0.250, 0.152, 0.100, and 0.080 mm internal diameters, respectively). During printing, the cartridge temperature was kept constant at 95° C. The extrusion pressure was optimized for each printing condition (i.e., starch concentration and nozzle diameter), as given in Table 1 below. The starch-based ink was deposited at room temperature (23° C.). Retrogradation was performed by keeping the gel beads at 4° C., then the beads were transferred to a freezer at −80° C. and finally dried for 24 h at −108° C. using a freeze dryer (VirTis benchtop SLC, PA, USA). High amylose corn starch and the printed starch particles with starch concentrations of 10%, 12.5%, and 15% are hereafter referred to as HACS, SP-10, SP-12.5, and SP-15, respectively.

### Macroscopic and Microstructural Observations.

The particle size of the 3D-printed starch particles was determined from their images using ImageJ software (public domain, National Institutes of Health, USA).

FEI Nova Nanolab 200 Dual-Beam system equipped with a 30 kV SEM FEG column and a 30 kV FIB column was utilized to visualize the structure of starch particles. The specimens were prepared by cutting cross-sections from the starch particles, and then the specimens were sputter-coated with a gold layer (EMITECH SC7620 Sputter Coater, MA, USA) to prevent electrical charging. Finally, the SEM images were taken at an acceleration voltage of 10 kV and a current of 10 mA.

Furthermore, pore size distribution was determined from the SEM images by measuring the size of randomly selected 50 open pores using ImageJ software.

### Density and Porosity.

The weight of a certain amount of the starch particles was divided by their volume to calculate the bulk density (ρ_{b}). The volume of the particles was determined by measuring the particles' dimensions using ImageJ software (National Institutes of Health, USA). The true density was measured using a helium pycnometer (Accupyc 1340, Norcross, GA, USA). The porosity (ε) was then determined using the bulk and true density.

### Fourier Transform Infrared Spectroscopy (FT-IR).

The structural features of HACS and starch particles were investigated using an IRAffinity-1S Fourier transform infrared spectroscopy (FTIR) unit (SHIMADZU Corp. Japan) equipped with a Quest attenuated total reflectance (ATR) accessory (Specac Company, Orpington, UK). The FTIR spectrum was acquired in the range of 4000 to 400 cm⁻¹ at a resolution of 4 cm⁻¹ with 64 scans.

### X-Ray Diffraction.

The crystalline structure of the 3D-printed starch particles was evaluated through an X-ray diffraction (XRD) analysis. The spectra were recorded using a PW3040 X'Pert MRD High-Resolution XRD (Philips, Almelo, Netherlands). The powdered starch particles were packed into the sample holder, and then they were scanned from 5° to 40° (2θ) with a step size of 0.02° at 45 kV and 40 mA. The XRD patterns were then used to calculate the degree of crystallinity based on Rabek's method.

### Thermal Properties.

Differential scanning calorimetry (DSC) measurements were performed using a PerkinElmer DSC 4000 calorimeter (MA, USA). Briefly, 8 μL of deionized water was added to 4 mg of powdered starch particles and sealed in 50 μL aluminum pans. The DSC measurements were then conducted in a heating cycle from 25 to 150° C. at a rate of 5° C./min under a nitrogen atmosphere. The DSC data were used to determine the gelatinization temperature and the melting point of amylose-lipid complexes.

### Statistical Analysis.

Analysis of variance (ANOVA), followed by the LSD comparisons of means test (p≤0.05), was performed with SPSS Statistics software.

### Macroscopic and Microstructural Observations.

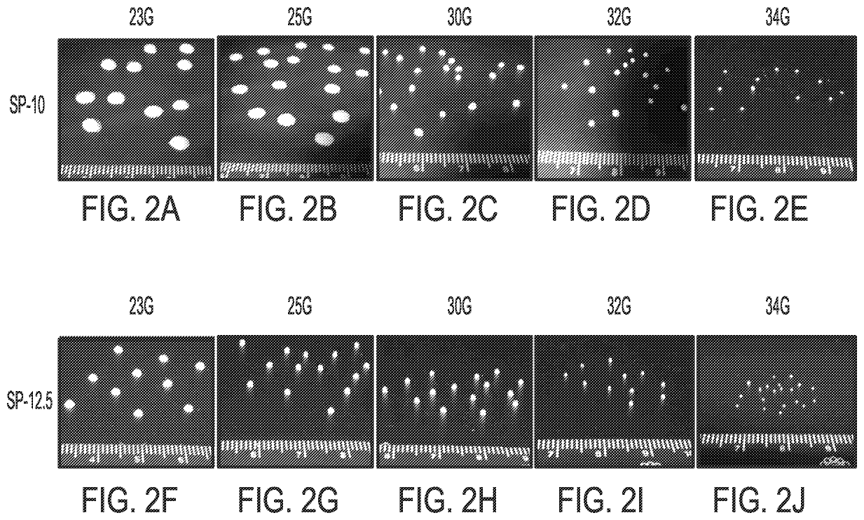

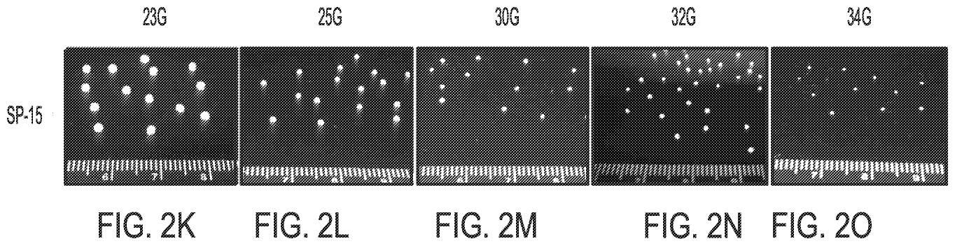

In creating 3D-printed particles, the ability of the ink to hold the desired shape and size after printing is as important as the technical capabilities during printing, such as the printing resolution of the 3D food printer. Therefore, the printing parameters, including starch concentration, extruder pressure, and nozzle size, were investigated, and the mean particle sizes of the 3D-printed particles were determined (Tables 1 and 2 below). The images of the 3D-printed starch particles are shown in FIGS. 2A through 2O, illustrating the excellent 3D printing consistency of the inventive 3D printing method.

TABLE 1
The 3D food printing parameters and mean particle size
of the starch particles.

| | Starch | Extruder | | | Mean |
|---|---|---|---|---|---|
| | concen- | temper- | Extruder | Nozzle | particle |
| | tration | ature | pressure | size | size |
| Sample | (wt. %) | (° C.) | (psi) | (ID, mm) | (μm) |
| A1 | 15 | 95 | 15 | 23 G (0.33) | 1507 ± 75 |
| A2 | 15 | 95 | 20 | 25 G (0.25) | 1158 ± 93 |
| A3 | 15 | 95 | 15 | 30 G (0.15) | 1006 ± 76 |
| A4 | 15 | 95 | 20 | 32 G (0.10) | 842 ± 103 |
| A5 | 15 | 95 | 25 | 34 G (0.08) | 650 ± 55 |
| B1 | 12.5 | 95 | 15 | 23 G (0.33) | 1869 ± 101 |
| B2 | 12.5 | 95 | 20 | 25 G (0.25) | 1272 ± 103 |
| B3 | 12.5 | 95 | 15 | 30 G (0.15) | 1151 ± 85 |
| B4 | 12.5 | 95 | 20 | 32 G (0.10) | 870 ± 89 |
| B5 | 12.5 | 95 | 25 | 34 G (0.08) | 712 ± 82 |
| C1 | 10 | 95 | 4 | 23 G (0.33) | 3501 ± 440 |
| C2 | 10 | 95 | 4 | 25 G (0.25) | 3061 ± 502 |
| C3 | 10 | 95 | 5 | 30 G (0.15) | 1814 ± 207 |
| C4 | 10 | 95 | 8 | 32 G (0.10) | 1203 ± 319 |
| C5 | 10 | 95 | 10 | 34 G (0.08) | 812 ± 91 |

Regarding the size and sphericity of the starch particles, the best results were obtained at 15% starch concentration, 25 psi, and nozzle 34G (FIG. 2L). As depicted in Table 2, the sphericity for SP-15 is close to 1, indicating that the beads are almost spheres. Nevertheless, the sphericity of SP-12.5 and especially SP-10 significantly deviated from 1. The results confirmed that by increasing the starch concentration, the resulting bio-ink enabled better retention of the spherical shape. However, the 3D printability could be maintained as long as the starch concentration, as the dominant factor, was higher than 10%. The average diameter of starch beads significantly decreased from 812 to 650 μm by increasing the starch concentration from 10 to 15% at a similar set of printing parameters (p<0.05). At the same starch concentration, nozzle size and printing pressure played important roles in achieving the desired bead size. Smaller nozzle diameters resulted in smaller bead sizes; however, higher printing pressure was required to create beads (FIGS. 2A-2O).

In a previous process, starch beads were generated using a dispersion-inverse gelation process where the starch paste was formed by heating a starch suspension at 100° C. for 30 min, and then it was added dropwise to soybean oil to create starch hydrogel beads. The size of the starch hydrogel beads ranged between 1.71-1.83 mm, which is ˜3 fold larger than the smallest beads obtained in these experimental examples. Yet, several ethanol washes were required to remove the soybean oil from the starch beads. In another previous process, smaller beads (215-1226 μm range) were obtained using an emulsion-gelation method in which oil:starch emulsions were formed and heated up to the high temperatures (95-140° C.) in a closed system (˜0.2 MPa) while stirring. Finally, after depressurization and cooling, the oil phase was removed by centrifugation and several ethanol washes. This process had a high shear (i.e., 1400 rpm) upon cooling, drastically affecting the bead size; a higher stirring rate created smaller beads.

TABLE 2
The mean bead size and sphericity of the 3D-printed starch beads.

| | Nozzle diameter | | | | | | | | | |
|---|---|---|---|---|---|---|---|---|---|---|
| Sample | 23 G | | 25 G | | 30 G | | 32 G | | 34 G | |
| | Mean bead size (μm) | | | | | | | | | |
| SP-10 | 3501 ± | 440^{a,A} | 3061 ± | 502^{b,A} | 1814 ± | 207^{c.A} | 1203 ± | 319^{d,A} | 812 ± | 91^{e,A} |
| SP-12.5 | 1869 ± | 101^{a,B} | 1272 ± | 103^{b,B} | 1151 ± | 85^{c,B} | 870 ± | 89^{d,B} | 712 ± | 82^{e,B} |
| SP-15 | 1507 ± | 75^{a,B} | 1158 ± | 93^{b,B} | 1006 ± | 76^{c,C} | 842 ± | 103^{d,B} | 650 ± | 55^{e,B} |
| | Sphericity | | | | | | | | | |
| SP-10 | 0.74 ± | 0.04^{a,A} | 0.72 ± | 0.05^{a,A} | 0.70 ± | 0.06^{a,A} | 0.71 ± | 0.03^{a,A} | 0.70 ± | 0.03^{a,A} |
| SP-12.5 | 0.88 ± | 0.01^{a,B} | 0.80 ± | 0.03^{b,B} | 0.78 ± | 0.04^{b,B} | 0.79 ± | 0.03^{b,B} | 0.77 ± | 0.03^{b,B} |
| SP-15 | 0.98 ± | 0.01^{a,C} | 0.86 ± | 0.02^{b,C} | 0.87 ± | 0.02^{b,c} | 0.90 ± | 0.05^{b,c} | 0.87 ± | 0.02^{b,C} |

*Means with different lowercase letters within the same column and means with different capital letters within the same row are significantly different according to the LSD test (p < 0.05).

By increasing starch concentration, the resulting bio-ink enabled better retention of spherical shape; however, the printability could be maintained as long as the starch concentration, as the dominant factor, was higher than 10%. The average diameter of starch particles decreased from 712 to 650 μm by increasing starch concentration from 12.5% to 15% at a similar set of printing parameters. At the same starch concentration, nozzle size, and printer pressure played important roles in achieving desired particle size. Smaller nozzle diameter resulted in smaller particle sizes; however, higher printing pressure was required to create particles.

In this illustrative example, by depositing hot starch paste (95° C.) at room temperature, the hydrogen bonding formed between amylose chains allowed self-supporting of the starch paste and retained the spherical shape without further curing process. The results indicated that monodisperse microspheres can be synthesized by optimizing starch concentration, 3D printing pressure, and nozzle size. However, the starch gel strength played the main role in spherical bead formation: the stronger the hydrogel, the better retention of its 3D shape.

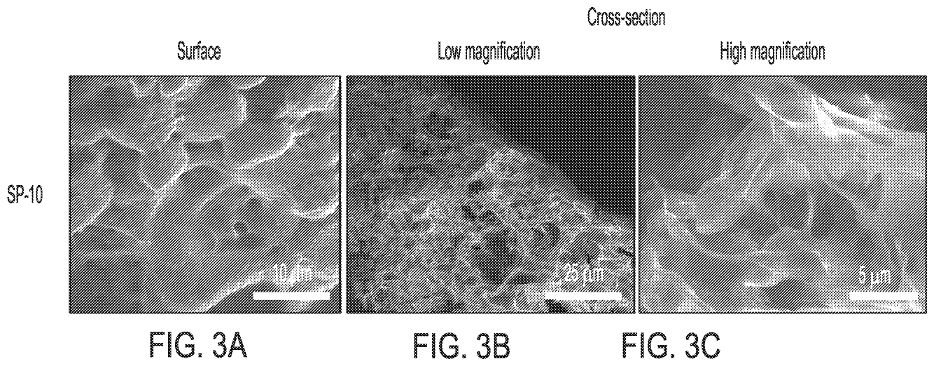

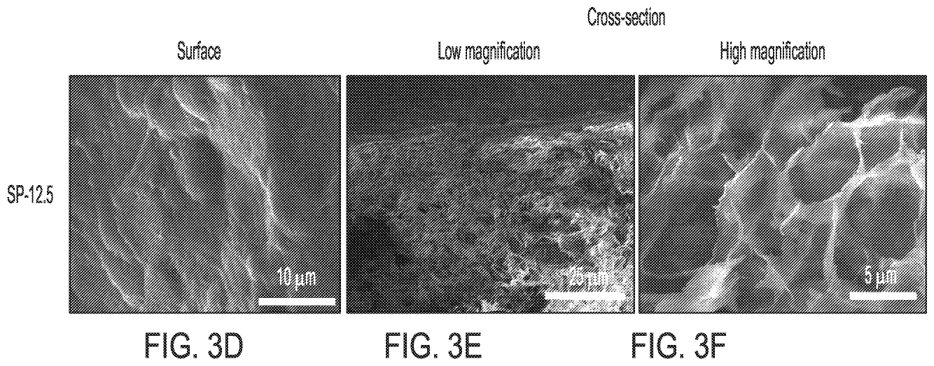

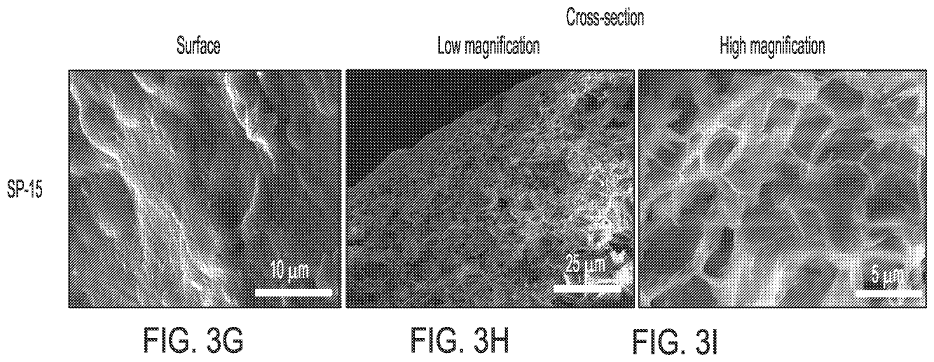

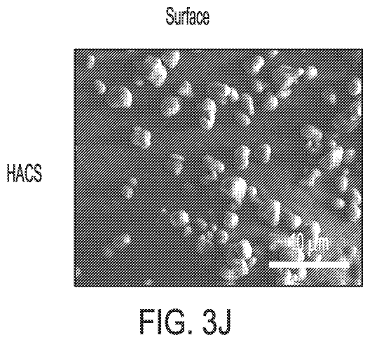

The morphology of the 3D-printed starch particles is depicted in FIGS. 3A through 3J. As shown in the SEM images, starch particles prepared using HACS consisted of a microporous matrix in which nonporous granule residues do not exist. The granule remnants can be a particular concern when developing small porous spheres. It is important to fabricate homogeneous structures without any granule residues for future applications, such as bioactive compound delivery. The heating of starch granules dispersed in an extra amount of water causes irreversible swelling of the granules and amylose dissolution. Complete dissolution of granules occurs if high enough temperature and shear are used. Granule residues in corn starch suspensions are not dissolved by only increasing the heating time, indicating the persistence of the granules during heating. HACS was processed at 95° C. using a high-shear mixer, which improved granular solubilization and produced a homogeneous matrix pertinently applied to generate porous spheres.

The surfaces of the 3D-printed starch particles are also shown in FIGS. 3A through 3J. A dense skin without any pores was formed at the free surface due to the starch matrix collapsing at the starch-air interface because of the water evaporation resulting in interfacial tension that generates surface skin. The thickness of this layer covering the surface of the particles significantly increased from 2.3 to 5.1 μm as the starch concentration increased from 10% to 15% (w/w) (p<0.05). This may provide advantages in protecting and delivering sensitive bioactive compounds.

Freeze-dried starch particles indicated an intricate network of thin, sheet-like matter divided by voids (FIGS. 3A-3J). This structure revealed the formation of ice crystals and their growth during freezing which compressed the starch matrix and resulted in the formation of macropores. For all three (3) concentrations, the internal structure throughout the particle was porous; however, starch concentration affected the size and distribution of pores in the 3D-printed particles. As seen from SEM images (FIGS. 3A-3J), higher starch concentration produced a more compact network.

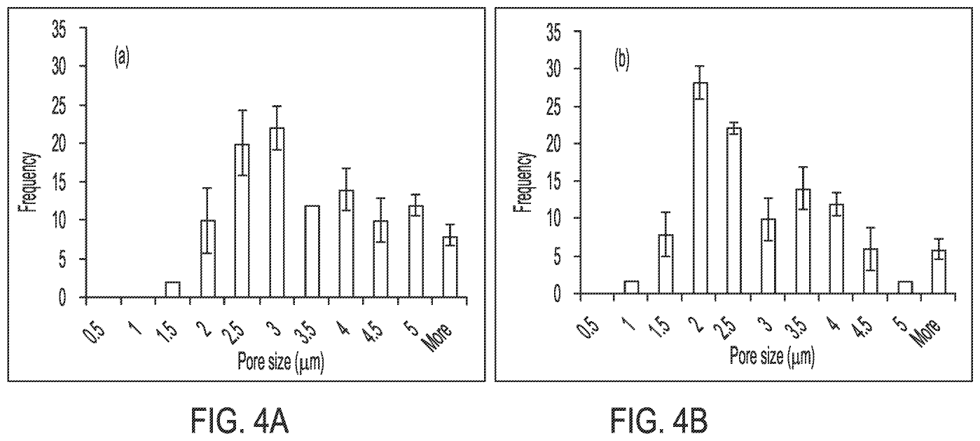

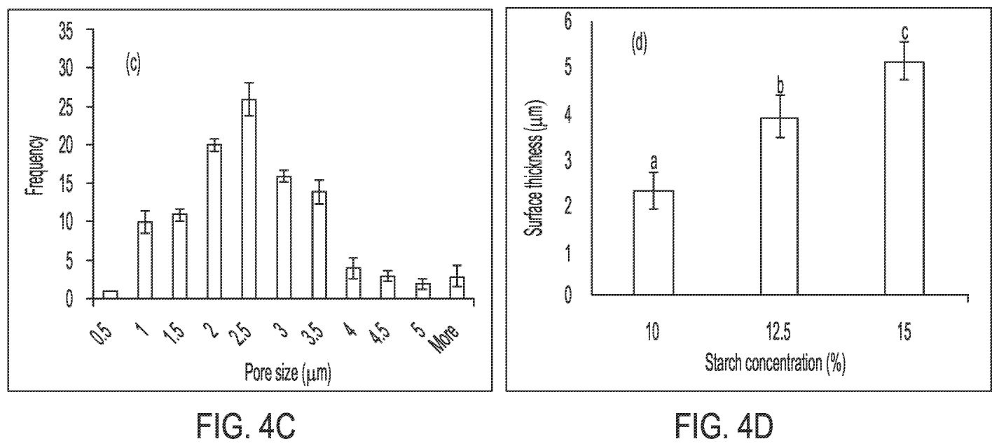

Furthermore, the macropore size distribution, ranging between 0.9 and 8 μm, is presented in FIGS. 4A through 4C. High starch concentration reduced the matrix pore size, which can be due to the gel formation that occurs more rapidly at higher concentrations resulting in the formation of denser starch networks. Moreover, at higher starch concentrations, the starch hydrogels are stronger and have less amount of water entrapped in their structure, increasing their stability against ice crystals' growth.

### Density and Porosity.

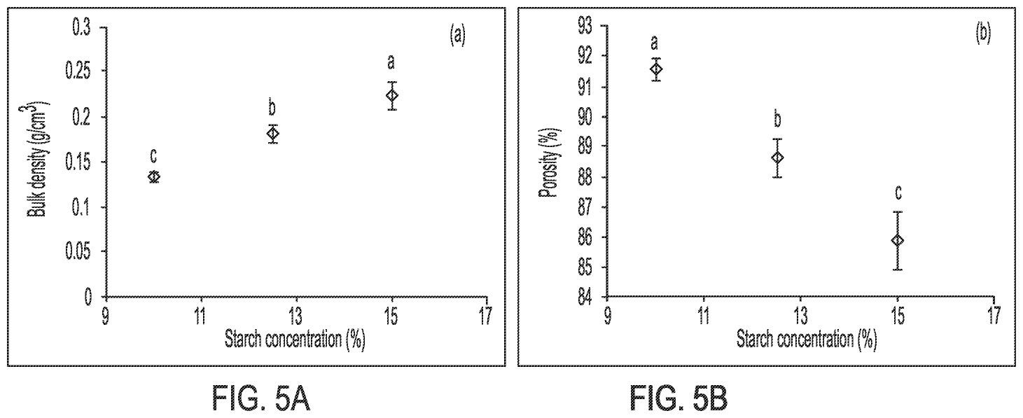

Density and porosity, as two main parameters, were measured to characterize the microstructure of the particles. The density and porosity of the starch particles are represented in FIGS. 5A and 5B as a function of starch concentration. As no solvent exchange was applied, no shrinkage was seen during the preparation of starch particles. Moreover, the high amylose content (72%) resulted in faster retrogradation and higher gel strength, increasing the resistance to the drying process. The starch particles had low densities ranging between 0.14-0.23 g/cm³. As expected, increased starch concentration resulted in higher density and lower porosity of the particles (FIGS. 5A-5B); this was confirmed with SEM images (FIGS. 3A-3J).

### Fourier Transform Infrared Spectroscopy.

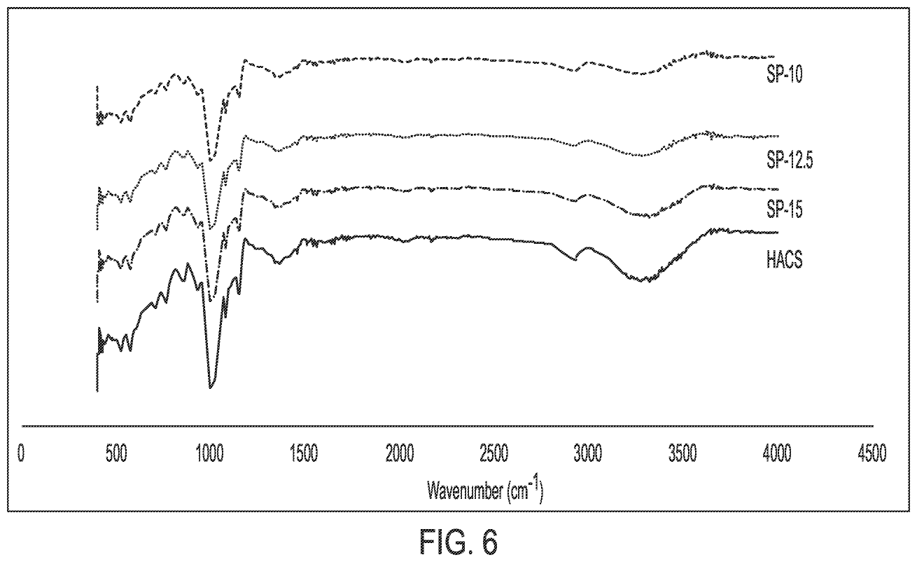

The chemical structure of starch particles was elucidated by an FTIR spectroscopy. The FTIR spectra demonstrated identical characteristic peaks; however, their intensities were slightly different (FIG. 6). A strong absorption peak centered at 3282 cm⁻¹ was ascribed to the OH stretching mode. The width of this peak implies the hydrogen bonding content. For starch particles, SP-10, SP-12.5, and SP-15, OH stretching peaks slightly shifted to the higher wavenumbers (3294, 3288, and 3286 cm⁻¹, respectively), which can be related to the reduction of crystalline structure. The absorption peak at 2923 cm⁻¹ was attributed to the —CH₂ stretching vibration. The C—H bending of CH₂ revealed IR peaks at 1433 and 1409 cm⁻¹. The other bands at 1150, 1105, and 990 cm⁻¹ were assigned to C—O, C—C, and C—O—H stretching vibrations, respectively. The characteristic peak at 864 cm⁻¹ was related to C—O—C at the β-glycosidic linkage.

FTIR spectra also determined the starch crystallinity by characterizing the changes in the amorphous and crystalline domains. As shown in FIG. 6, the strong IR peak at 995 cm⁻¹ revealed two shoulders at 1022 cm⁻¹ and 1054 cm⁻¹, which exhibited the amorphous and crystalline bands, respectively. The higher intensity of the shoulder appearing at 1022 cm 1 suggests the higher extent of short-range double helices. The intensity of this peak increased in the IR spectra of starch particles, confirming the less content of crystalline structure. The intensity ratio of these two shoulders as 1054/1022 cm⁻¹ was also quantified to compare the crystallinity of the starch particles. This ratio decreased in starch particles compared to HACS, confirming the loss of crystalline structure during gelatinization. For HACS, SP-10, SP-12.5, and SP-15, the 1054/1022 cm⁻¹ were calculated as 1.48, 1.23, 1.27, and 1.34, respectively. The single peak at 1646 cm⁻¹ was attributed to the water tightly bound through hydrogen bonding as part of the crystalline structure. As shown in the FTIR spectra (FIG. 6), this peak almost disappeared in the 3D-printed starch particles, suggesting the reduction of crystallinity after gelatinization.

### X-Ray Diffraction.

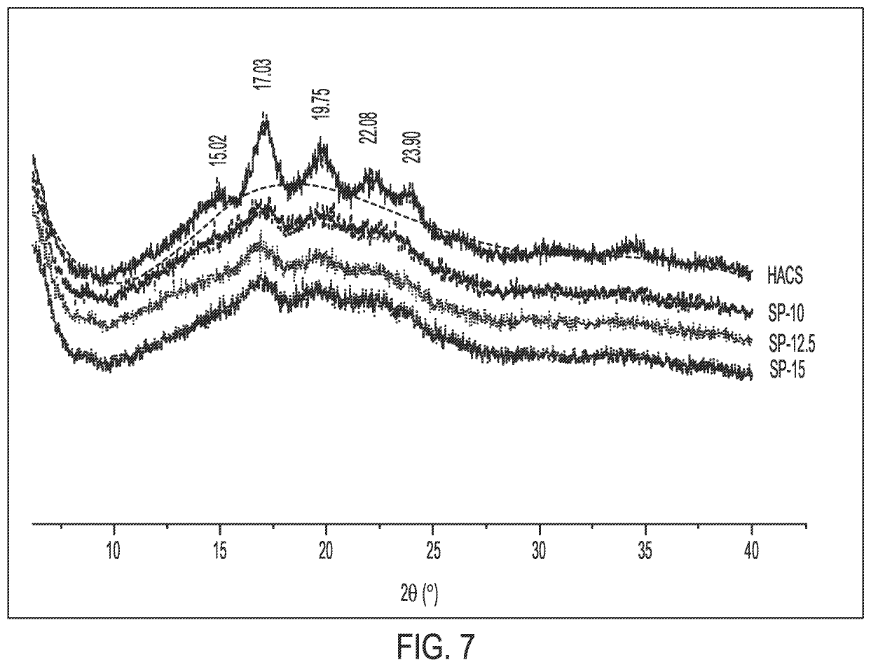

The diffraction profiles of HACS and 3D-printed starch particles are shown in FIG. 7. The crystalline part of the high amylose corn starch was displayed by five diffraction peaks at 2θ=15.02°, 17.03°, 19.75°, 22.08°, and 23.90°, representing the B-type XRD pattern. High amylose starches typically show the B-type XRD pattern, which is identified by five XRD peaks at 2θ=15.26°, 17.21°, 19.75°, 22.32° and 24.08°.

As expected, the intensity of the sharp peaks observed in the XRD pattern of HACS became significantly weaker and broader, indicating the decrease in crystallinity after the gelatinization for all three (3) concentrations. The relative crystallinity was calculated by dividing the diffraction patterns by the crystalline peaks and amorphous region and found to be 8.78, 5.64, 6.33, and 7.33% for HACS, SP-10, SP-12.5, and SP-15, respectively. The crystallinity of SP-15 was slightly higher than SP-10 and SP-12.5, probably due to the heavier starch recrystallization during retrogradation.

### Thermal Properties.

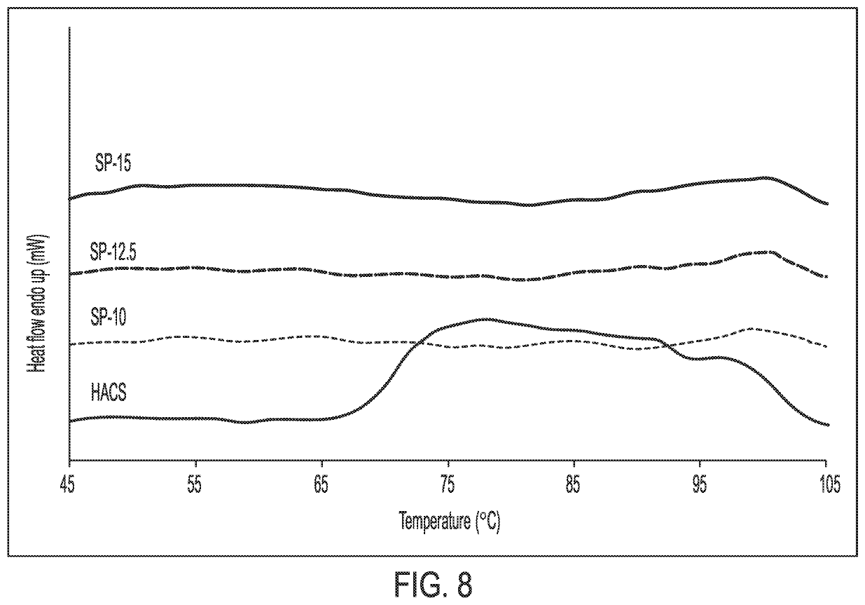

Representative DSC thermograms of HACS and 3D-printed starch particles are shown in FIG. 8. Two endothermic peaks (I and II) were observed in the DSC thermogram of HACS, with the main peak appearing at 70° C. and the other smaller peak at 95° C. The first endotherm peak appears due to the melting of the amylopectin crystalline structure and/or disrupting the double helices formed in amylopectin side chains, while the second DSC endothermic peak is associated with the amylose-lipid complexes melting. Contrary to the melting of amylose, the amylopectin phase transition is irreversible. The peak ascribed to the amylopectin melting disappeared when the starch dispersions were rescanned by DSC, and only the amylose melting peak appeared at 95° C. in the endothermic profile. As shown in FIG. 8, the first peak almost disappeared in DSC thermograms for starch particles confirming the irreversible melting of amylopectin crystalline structure through gelatinization and 3D printing.

Generally, starches have a lipid content between 0.5 to 1.5%. Therefore, the lipid content is considered the other parameter affecting the thermal properties of starches. During starch gelatinization, amylose-lipid complexes are formed since amylose has the innate ability to bind lipids. Amylose-lipid endotherms in HACS and starch particles were observed at 97.3 and 101.4° C., respectively.

### Rheological Properties.

The rheological behavior of the bio-ink is critical for extrusion-based 3D printing. The desired properties, including shape stability and resolution, highly depend on the rheological properties of the printing material. Specifically, the ink should show shear-thinning behavior with appropriate flow stress to be printable using an extrusion-based 3D printer, especially with a small nozzle size. Starch pastes consist of entangled amylose molecules creating a continuous network strengthened by swollen granules. This specific structure grants starch pastes the required viscoelastic properties (i.e., a shear-thinning behavior) for extrusion-based 3D printing.

### Viscosity.

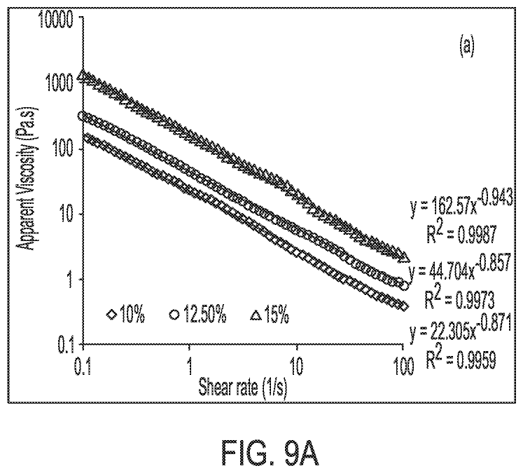

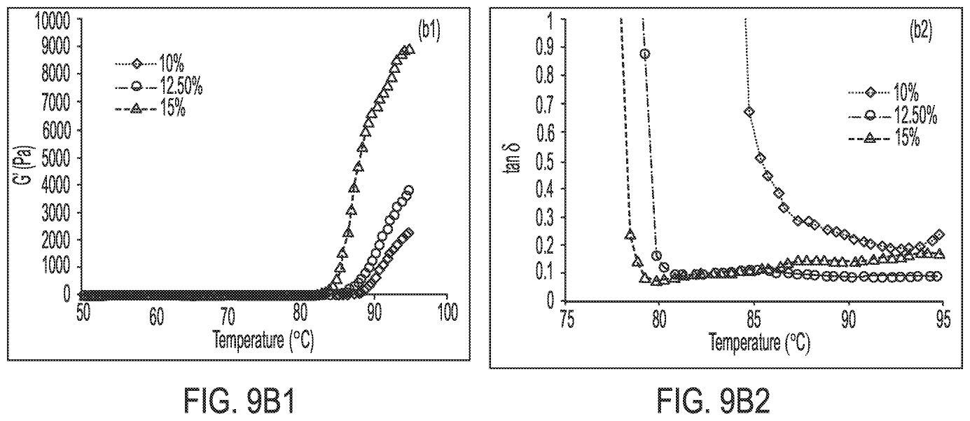

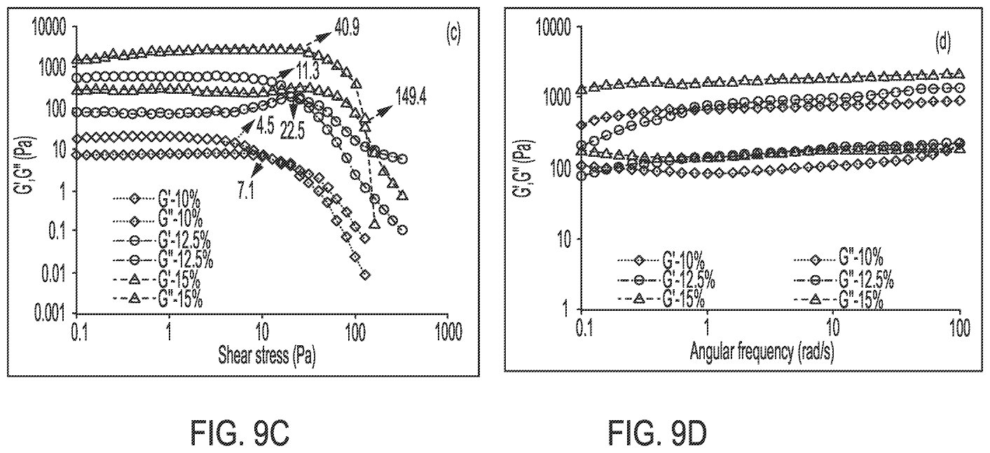

The steady shear rheological parameters were measured to investigate the viscoelasticity of starch suspensions as the ink for extrusion-based 3D printing. The viscosity increased at a constant shear rate as the starch concentration increased (FIG. 9A). The double logarithmic plot of various starch concentrations shows a linear correlation between viscosity and shear rate. Therefore, the rheological behavior was described using the power-law model.

$$η = K {γ}^{n - 1} \qquad ( Equation 1 )$$

where η, K, γ, and n are the viscosity (Pa·s), the consistency (Pa·s), the shear rate (s⁻¹), and the power-law index, respectively. The power-law parameters are presented in Table 3. For all three starch concentrations, n is smaller than 1, indicating a non-Newtonian fluid that shows shear-thinning behavior. The viscosity increased by increasing the starch concentration at the same shear rates.

### Temperature Sweeps.

Storage modulus (G′) and tan δ are two parameters reflecting the viscoelastic characteristics of starch paste. The gelatinized starch obtained by increasing the temperature of a starch solution was able to respond to the elastic deformation and support the printed object. The relationship of G′ and tan δ with temperature for three starch concentrations are shown in FIGS. 9B1 and 9B2 and Table 3. A similar profile was observed for all specimens during the temperature sweeps. Since the starch remained undissolved in cold water, G′ did not change at low temperatures. By increasing the temperature beyond a certain point (80-90° C.), G′ extensively increased, and tan δ dramatically decreased due to the swelling of granules resulting in the formation of a closely packed network. Heating elevated the swelling of granules and amylose leaching out, which led to the formation of a 3D matrix through the collision of amylose chains and swollen starch granules, which contributed to the increase in G′ values.

TABLE 3
Gel strength, loss tangent, yield stress, flow stress, and power-
law parameters of the starch pastes with different concentrations.

| | G′ | Tan δ | Yield | Flow | | | |
|---|---|---|---|---|---|---|---|
| | (at 95° | (at 95° | stress | stress | Power-law parameters | | |
| Sample | C.) | C.) | (Pa) | (Pa) | n | K | R² |
| SP-10 | 2216 ± | 0.215 ± | 4.5 ± | 7.12 ± | 0.129^{b} | 22.3^{a} | 0.996 |
| | 115^{a} | 0.0169^{c} | 0.5^{a} | 0.81^{a} | | | |
| SP-12.5 | 3851 ± | 0.088 ± | 11.3 ± | 22.53 ± | 0.143^{c} | 44.70^{a} | 0.996 |
| | 528^{b} | 0.004^{a} | 1.2^{a} | 2.58^{a} | | | |
| SP-15 | 8947 ± | 0.160 ± | 40.9 ± | 142.2 ± | 0.057^{a} | 162.57^{b} | 0.997 |
| | 292^{c} | 0.004^{b} | 8.8^{b} | 16.3^{b} | | | |

*Means with different lowercase letters within the same column are significantly different according to the LSD test (p < 0.05).

Higher starch concentrations resulted in higher G′ values (FIG. 9B1, Table 3). Based on the previous studies, G′ values higher than 500 Pa, and tan δ smaller than 0.2 describe starch suspension as an elastic gel. The gel with a 15% starch concentration was stiffer than the ones obtained with lower starch concentrations (10 and 12.5%); therefore, it provided better control over shape fidelity, making it more desirable as a bio-ink for 3D printing.

### Stress Sweeps.

The highest starch concentration (15%) revealed the highest G′ (FIG. 9C). Starch hydrogels with 10, 12.5, and 15% concentrations yielded stress values of 4.5, 11.3, and 40.9 Pa, respectively. As a critical parameter to support the shape of the printed object, the mechanical strength of the printing material is reflected by the yield stress. The yield stress is affected by the swelled granules and the amylose chains, as discussed for G′. The point at which G′ and G″ values are equal was also determined as the flow stress presenting the extrudability of the ink based on the force required for extrusion. FIG. 9C and Table 3 show that yield and flow stress were concentration-dependent. The 15% starch hydrogel had higher yield stress indicating higher printability and resolution due to the stronger mechanical characteristics, while its higher flow stress required a stronger force (i.e., higher printing pressure) for printing through the nozzle compared to the lower concentrations. The higher yield stress values led to the higher resistance of the starch hydrogels to deformation and produced 3D-printed beads with a higher resolution and no defects.

### Frequency Sweeps.

The frequency sweeps of the storage (G′) and loss (G″) moduli at 95° C. are depicted in FIG. 9D. The mechanical strength of the starch hydrogels is denoted by G′, while the viscous response of the hydrogels is measured by G″. For all samples, G″ was smaller than G′, indicating the dominant elastic properties of the system. At a constant angular frequency, G′ and G″ increased as the starch concentration increased, indicating that the viscoelastic properties of the starch hydrogels correlated with the starch concentration. This caused the SP-10 to deviate from the spherical shape because the mechanical strength was not high enough to support the shape of the 3D-printed beads. Overall, the starch concentration of 15% was the best concentration among the samples investigated to produce small starch beads using 3D food printing.

### Example 2: System and Method of Extrusion-Based Three-Dimensional Food Printing for Fabricating Alginate-Pectin Hydrogel Particles

In the following example, the system and method of extrusion-based 3D food printing generated alginate-pectin (Al-P) hydrogel particles containing varied total gum concentrations (“TGC”) at a constant Al:P ratio of 80:20. The 3D food printing conditions, namely, TGC (1.8, 2.0, and 2.2 wt. %) and nozzle size (0.108, 0.159, and 0.210 mm), were investigated. The 3D food printing system and method disclosed herein were compared with the conventional bead formation method via a peristaltic pump. As demonstrated below, all Al-P printing inks exhibited a shear-thinning behavior, and the increased apparent viscosity, loss, and storage moduli were associated with the increase in the TGC. The size of the wet 3D-printed Al-P hydrogel particles ranged between 1.27-1.59 mm, which were smaller than that produced using the conventional method (1.44-1.79 mm). Freeze-dried Al-P particles showed a porous structure with reduced crystallinity, and no chemical interaction was observed between alginate and pectin.

### Materials.

Pectin (AM 800) in powdered form was obtained from Ingredion (Westchester, IL). The degree of esterification (DE) of the pectin was 69-72%. Alginic acid sodium salt with medium viscosity (˜3500 cps, 2% aqueous solution) was obtained from MP Biomedicals (Solon, OH). Calcium chloride (CaCl2) with 97 wt. % purity was purchased from Alfa Aesar (Haverhill, MA).

### Preparation of Alginate-Pectin Gel Solution.

Solutions of 1.75 and 2.0 wt. % alginate and 4.0 wt. % pectin were prepared by dissolving the powders in deionized water using a magnetic stirrer at ambient temperature (23° C.) for 2.5 h. The different solutions were mixed in various ratios to obtain the appropriate TGC and Al-P weight percent ratio after being incubated at 4° C. for 8 h to permit air bubbles to rise. Al-P solutions of 1.6-3.0 wt. % TGC were created for screening studies, with the Al-P weight ratio kept constant at 80:20.

### Preparation of Hydrogel Particles Via the Conventional Method.

To manufacture the Al-P hydrogel particles via the conventional method, a peristaltic pump (Masterflex L/S, Cole Parmer, IL, USA) was used. The Al-P solution was extruded through 0.337 mm, 0.210 mm, 0.159 mm, and 0.108 mm inner diameter needles (Allevi, 3D Systems, Inc., PA, USA) at room temperature (23° C.) with a volumetric flow rate of 0.027 mL/s and a dropping distance of 2.5 or 5 cm, in order to obtain spherical particles. The nozzle size of 0.337 mm was selected, while nozzle sizes of 0.210, 0.159, and 0.108 mm were used to compare the conventional method with the system and method of extrusion-based 3D food printing described below. The extruded droplets formed hydrogel particles as they interacted with the 0.1 M CaCl₂) curing solution for 3-4 h, following the conventional concentration of 0.1 M CaCl₂) utilized for Ca-alginate bead manufacturing. The concentration of the CaCl₂) solution was kept constant throughout the study.

### Preparation of Hydrogel Particles Using 3D Food Printing.

The hydrogel particles were obtained via a droplet extrusion-based method using a 3D food printer (Allevi 2, 3D Systems, Inc., PA, USA) equipped with two 10-mL cartridges. The extrusion system was operated with pneumatic pressure (1-120 psi). The alginate-pectin solutions were loaded into one of the cartridges and extruded through 0.210 mm, 0.159 mm, and 0.108 mm inner diameter needles (Allevi, 3D Systems, Inc., PA, USA) at room temperature (23° C.). Extrusion height was adjusted to 2.5 or 5 cm, while the printing speed was kept constant at 6 mm/s. A .stl file of a sphere was selected using the Bioprint Pro software for releasing a known amount of the Al-P solution into the CaCl₂) solution. The extrusion time was 1 s for each hydrogel droplet. Table 4 below lists the system and method of extrusion-based 3D food printing conditions studied. The extruded droplets formed hydrogels as they interacted with 0.1 M CaCl₂) solution. The particles were hardened in the CaCl₂) solution for 3-4 h. Finally, they were washed thoroughly with deionized water to remove excess CaCl₂) ions from the hydrogel particles.

TABLE 4
3D printing conditions of alginate-pectin hydrogel particles.

| Total gum | | Extrusion |
|---|---|---|
| concentration | Nozzle size | pressure |
| (wt. %) | (I.D. mm) | (psi) |
| 1.8 | 0.210 | 18 |
| | 0.159 | 25 |
| | 0.108 | 50 |
| 2.0 | 0.210 | 23 |
| | 0.159 | 28 |
| | 0.108 | 54 |
| 2.2 | 0.210 | 27 |
| | 0.159 | 34 |
| | 0.108 | 60 |

### Rheological Properties.

The AR 1000-N Rheometer (TA Instruments, DE, USA), a controlled-stress rheometer equipped with a Peltier Plate temperature control device and a 40 mm parallel-plate geometry, was used to study rheological properties of Al-P solutions with varying total gum concentrations. The temperature was set at 25° C., and the experimental gap was adjusted to 1.00 mm. The linear viscoelastic region (LVR) was identified by performing strain sweep tests at a frequency of 1 Hz. For all experiments, the equilibration time was set to 5 minutes at 1 Hz with 0.01% strain falling within the LVR. The angular frequency was increased from 0.6 to 250 rad/s at 1 Pa for the angular frequency sweep test, and the elastic (G′) and viscous (G″) moduli were recorded.

### Particle Size Analysis.

The size of the wet Al-P hydrogel particles generated via the conventional method and particles produced with the 3D food printing system and method was determined using their images taken by a conventional digital camera. ImageJ software (ImageJ 1.53k, National Institutes of Health, USA) was used for this measurement. Randomly selected 20 particles were used to determine the mean particle size.

The particle size was measured for TGCs of 1.8, 2.0, and 2.2 wt. %, with nozzle sizes of 0.337 mm, 0.210 mm, 0.159 mm, and 0.108 mm inner diameter for particles generated by the conventional method, and nozzle sizes of 0.210 mm, 0.159 mm, and 0.108 mm inner diameter for particles formed by the system and method of extrusion-based 3D food printing. The size of the particles generated through a nozzle size of 0.337 mm inner diameter was investigated to compare the results with the study conducted by Guo and Kaletunç (2016).

### Freeze-Drying of the Particles.

The washed Al-P hydrogel particles were frozen at −80° C. for 3 h before being lyophilized (SP VirTis BenchTop SLC, SP scientific, NY, USA) for 2 days at a condenser temperature of −108° C. under vacuum pressure of 0.015 kPa. After drying, the beads were placed in a container and immediately sealed for future use.

### Density and Porosity.

The true density of the freeze-dried Al-P particles was measured using a gas displacement pycnometer system (AccuPyc II, Micromeritics Instrument Corporation, GA, USA), where helium was used as the displacement medium. The bulk density of the particles was determined by measuring their weight and volume. Then, the porosity (%) was determined using the true and bulk densities by the following equation:

$$ε = ( 1 - ρ\_bulk / ρ\_true ) * 100 \qquad ( Equation 2 )$$

### Morphology of the Dried Particles.

For morphological analysis, scanning electron microscopy (SEM) micrographs of dry Al-P particles were generated using an FEI Nova Nanolab 200 Dual-Beam system equipped with a 30 kV SEM FEG column and a 30 kV FIB column. Specimens were prepared by cutting thin cross-sections from the particles, which were subsequently sputter-coated with a thin gold layer using a sputter coater (EMITECH SC7620 Sputter Coater, MA, USA). SEM images were captured at various magnifications ranging from 1,000-20,000× at an acceleration voltage of 15.0 kV, and an electric current of 10 mA.

### X-Ray Diffraction.

The X-ray diffraction patterns of dry Al-P particles with various TGCs were recorded at ambient temperature (23° C.) using a PW3040 X'Pert MRD High-Resolution XRD (Philips, Almelo, Netherlands). Powdered particles were analyzed at two theta angles ranging from 5° to 55° at a voltage of 45 kV, an electric current of 40 mA, and with a scan step size of 0.02°. The same procedure was applied to analyze pure alginate and pectin.

### Fourier Transform Infrared (FTIR) Spectroscopy.

An FTIR spectrometer (IRAffinity-1S, Shimadzu, Japan) equipped with a Quest attenuated total reflectance (ATR) was utilized to acquire the FTIR spectra of the freeze-dried Al-P particles with different TGC (i.e., 1.8, 2.0, and 2.2 wt. %). The dried Al-P particles were ground prior to the analysis. The FTIR spectra were generated in the wavelength range of 400 to 4000 cm⁻¹ at a resolution of 4 cm⁻¹ with 64 scans.

### Statistical Analysis.

The data in this experiment were analyzed by R (Version 4.0.4., R Foundation for Statistical Computing, Vienna, Austria) using a one-way analysis of variance (ANOVA) with Tukey's multiple comparison tests at a 95% confidence level. The hydrogel beads were produced in triplicates for each processing condition. All other experiments were conducted at least in duplicates. The results are presented as the mean value=standard deviation.

### Preparation of the Hydrogel Particles.

In this demonstration, the droplet extrusion method was used to generate the Al-P hydrogel particles utilizing a peristaltic pump or a 3D food printer. Droplet extrusion is a manufacturing method wherein a biopolymer solution is extruded through a capillary and permitted to split away from the needle in droplet form affected by a gravitational force or external force into a curing solution. Although Al-P hydrogel particles were formed upon contacting the CaCl₂) solution in both systems, the traditional pump method had a constant flow of the polymer solution dripping into the CaCl₂) solution, whereas the system and method of extrusion-based 3D food printing released a known amount of Al-P solution for each hydrogel particle, which was determined by the .stl file used in the printing software. The biopolymer used in this demonstration was Al-P, and the curing solution was 0.1 M CaCl₂) solution for bead manufacturing due to its effect on bead size, structure, and potential encapsulation applications. Even though high methoxyl pectins do not have enough affinity to Ca²⁺ to form a gel at pH 5-7, they can form strong gels at lower pHs (˜3) in the presence of a solute. Therefore, Al-P composite polymers were used together to create hydrogel particles that could provide extra protection in acidic environments, such as the stomach. For example, in a previous study, Al-P hydrogel particles generated without Ca²⁺ ions stayed intact at pH 3.0 for 23 days (Guo & Kaletunç, 2016).

In the preliminary studies, hydrogel particles were prepared at eight TGCs (i.e., 1.6, 1.8, 2.0, 2.2, 2.4, 2.5, 2.7, and 3.0 wt. %) and two drop heights (i.e., 2.5 and 5 cm). The capacity to produce particles with the smallest needle size (i.e., 0.108 mm) resulted in the exclusion of TGC greater than 2.2 wt. % due to the undesirable high pressure (i.e., pressures greater than 65 psi). On the other hand, due to the low viscosity properties, total gum concentrations less than 1.8 wt. % were unable to form spherical particles using the system and method of extrusion-based 3D food printing with the largest nozzle size (i.e., 0.210 mm), and therefore, they were excluded from the experimental plan. As a result, the TGC was set to be between 1.8 and 2.2 wt. % for further hydrogel particle preparation and characterization. In addition, the drop height of 2.5 cm was eliminated as the produced particles with this drop height were not in a spherical shape. Consequently, all Al-P hydrogel particles were formed at a drop height of 5.0 cm.

### Rheological Properties.

The apparent viscosity of the gel solutions used as 3D printing inks is expected to be low enough to permit easy extrusion through the nozzle tip while being sufficiently high to allow the ink to be stacked with previously deposited layers. In extrusion-based 3D printing, the viscosity reduction caused by shear deformation is defined as shear-thinning behavior, which helps the ink to flow smoothly through a small deposition needle. However, the viscosity of the ink is recovered upon depositing, resulting in better shape integrity.

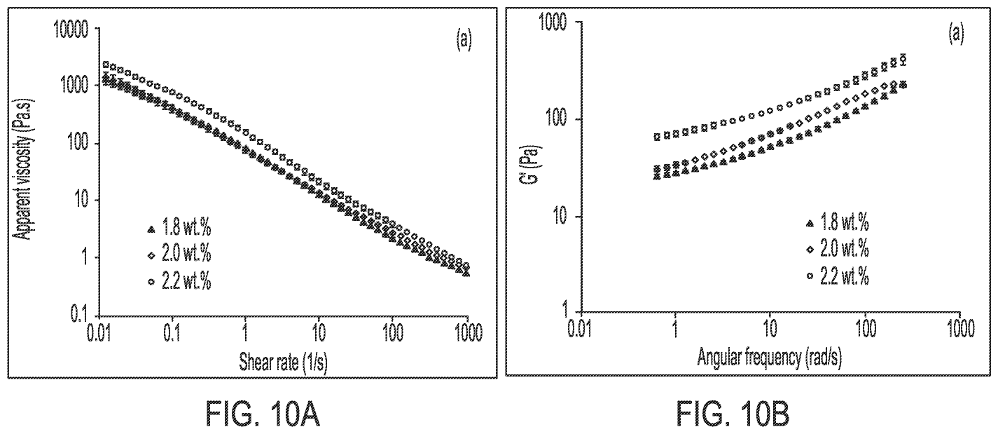

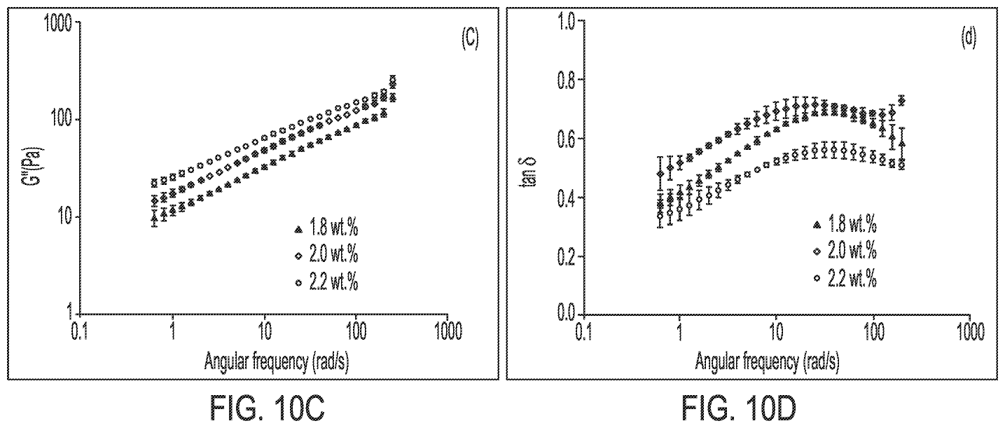

The apparent viscosities of the Al-P solutions as a function of shear rate are illustrated in FIG. 10A. The apparent viscosity increased with increasing the TGC. This is due to the alginate and pectin's tendency to form hydrogen bonds with water molecules, resulting in a denser network. Hydrocolloids form strong structures by water removal from the system. Also, hydrogen bonds formed between chains of sodium alginate and pectin in combined systems increase the portion of bound water. Therefore, in this study, free water has decreased by increasing the TGC, resulting in a stronger network and higher viscosity.

All the Al-P solutions exhibited shear-thinning behavior, associated with gradually decreased apparent viscosity with increasing shear rate, and suggested that all pastes were non-Newtonian fluids, which is critical to achieving a successful 3D printing. The mechanical spectrum of a material can be represented as a variation of G′ and G″ with angular frequency. The solid-like behavior (G′) dominates the liquid-like, viscous characteristics (G″) in a typical mechanical spectrum of polysaccharide solutions and gels. The strength of the gel formed between alginate and pectin is associated with their chemical structure. With an increase in DE, methyl groups on the pectin chain reduce the electrostatic repulsions, leading to a better molecular association and the formation of stronger gels. In the present example, high methoxyl pectin (DE: 69-72%) was used with alginate, generating hydrogels with appropriate printability.

FIGS. 1B and 1C illustrate the logarithmic representation of the G′, and G″, respectively, as a function of the angular frequency, revealing the characteristic spectrum of a hydrogel. The highest absolute values of both G′ and G″ were observed in the hydrogel solution with the highest TGC. In addition, G′ was higher than G″ for all the samples, confirming the dominant solid-like behavior. However, the almost parallel increase in G′ and G″ curves with the increase in the angular frequency reveals a weak Al-P gel formed. This was further investigated by determining the loss tangent (tan δ=G″/G′) (FIG. 10D). Tan & gives information about the relative mechanical strength of the gel solutions, where tan δ<0.1 indicates strong, self-standing gels while 1>tan δ>0.1 reveals weak, paste-like gels, and tan δ>1 shows a liquid-like behavior. The tan δ values for all solutions investigated lay between the range of 1>tan δ>0.1, indicating an overall paste-like gel behavior.

### Particle Size.

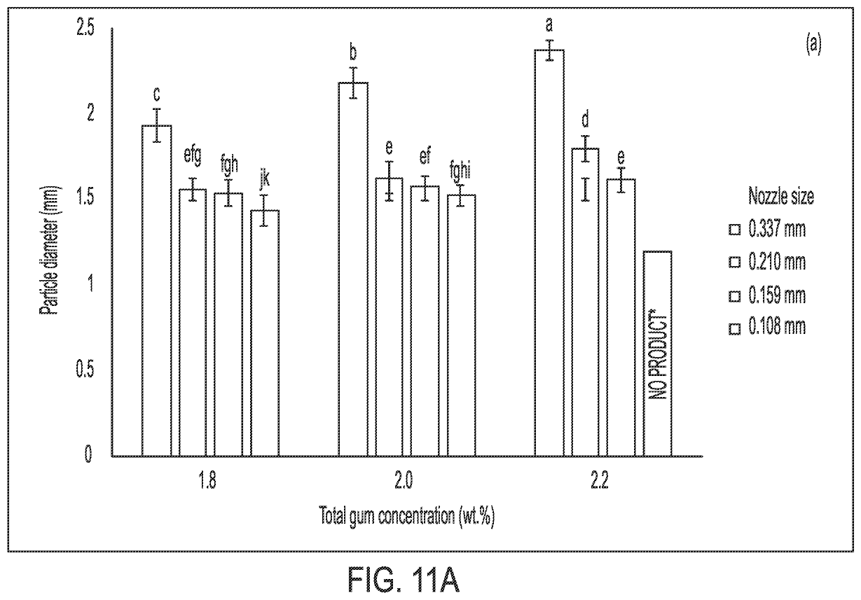

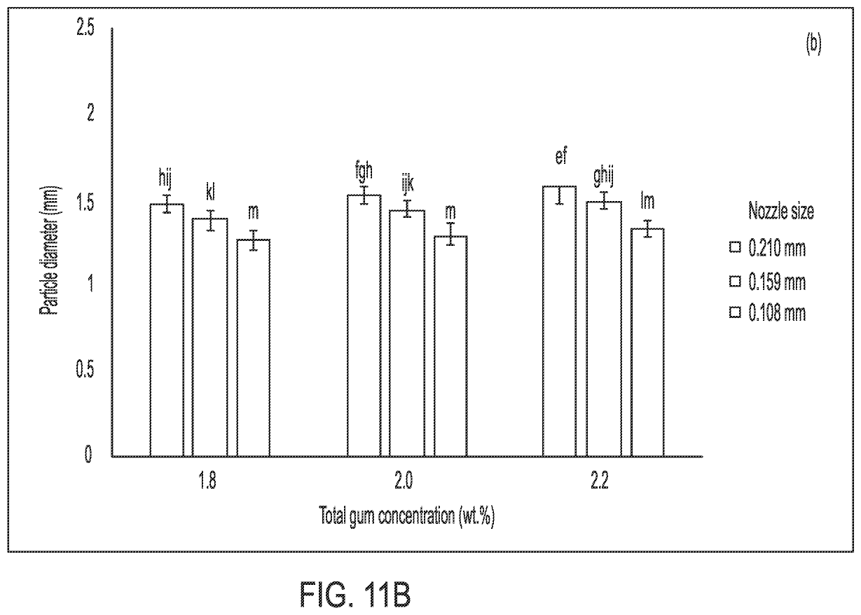

FIG. 2 shows the average particle size of the wet Al-P hydrogel particles generated via the conventional method (FIG. 11A), as well as produced utilizing the system and method of extrusion-based 3D food printing (FIG. 11B). All the generated Al-P hydrogel beads were in a spherical shape (FIG. 12). The particle size of the Al-P hydrogel beads varied between 1.44-1.79 mm when the peristaltic pump was used with different nozzle sizes (0.108-0.210 mm) and TGC (1.8-2.2 wt. %) (FIG. 11A). On the other hand, the system and method of extrusion-based 3D food printing created particles in the range of 1.27-1.59 mm (FIG. 11B). When the particles were created using the peristaltic pump rather than the system and method of extrusion-based 3D food printing under identical conditions, such as using the same nozzle size and TGC, the particles produced were significantly larger (p<0.05). For example, the Al-P hydrogel particles generated via the system and method of extrusion-based 3D food printing using a TGC of 1.8 wt. % with a nozzle size of 0.108 mm had a particle size of 1.27 mm, whereas the Al-P hydrogel particles produced using the peristaltic pump at the same conditions resulted in significantly larger particle size of 1.44 mm (p<0.05) (FIG. 11). Compared to the particles produced with the system and method of extrusion-based 3D food printing, the particles created with the peristaltic pump showed larger variations in their size; specifically, the standard deviation was approximately 39.5% greater. Furthermore, using the peristaltic pump with the smallest nozzle size (0.108 mm) and the highest TGC (2.2 wt. %) resulted in no particle formation due to the pressure build-up in the system.

As the TGC increased from 1.8 to 2.2 wt. %, the hydrogel particle size significantly increased for both systems (i.e., system and method of extrusion-based 3D food printing and peristaltic pump), especially with larger nozzle sizes (e.g., 0.210 and 0.159 mm). This can be due to the increase in the viscosity of Al-P solutions as the TGC was increased (FIG. 10A). Specifically, as the viscosity of the Al-P solutions increases, it is more difficult for the particles to separate from the tip of the nozzle. Furthermore, the particle size of Al-P hydrogel beads decreased with decreasing the nozzle size as expected (FIG. 11). The smallest Al-P particles (1.27 mm) were obtained via the system and method of extrusion-based 3D food printing with the smallest nozzle size (0.108 mm) and lowest TGC (1.8 wt. %). However, the particle size only slightly increased to 1.30 and 1.34 mm (p>0.05) when the TGC increased to 2.0 or 2.2 wt. % under these conditions (FIG. 11B).

Guo and Kaletunç (2016) obtained spherical Al-P particles utilizing a peristaltic pump where the particles were produced using a 2.2 wt. % TGC (82:18 alginate:pectin ratio) gel solution with a 0.337 mm nozzle size at a 5 cm drop height. The Al-P particles generated at these conditions had a particle diameter of 2.68 mm (Guo & Kaletunç, 2016). Using the identical needle size, equipment, TGC, and drop height, spherical particles with an average diameter of 2.37 mm were created in this study. The different alginate:pectin ratio (80:20 vs. 82:18), curing solution (0.1 M CaCl₂) vs. 0.1 M pH 1.2 HCl/KCl buffer), and volumetric flow rate (0.027 vs. 0.017-0.022 mL/s) could explain the variation in the particle sizes. These differences in alginate:pectin ratio, curing solution, and volumetric flow rate were due to following a different method to prepare the solutions (Belščak-Cvitanović et al., 2015), more practical applications with the system and method of extrusion-based 3D food printing, and peristaltic pump limitations, respectively. Furthermore, a study conducted by Kiaei Pour, Alemzadeh, Vaziri, and Beiroti (2020) obtained Al-P hydrogel particles with a particle size of 4.10 mm using a 1.8 wt. % TGC and 80:20 alginate:pectin ratio. The microcapsules were prepared using a syringe pump by dripping the Al-P solution into a 1 M CaCl₂) solution through a 0.6 mm syringe needle at a flow rate of 1.0 mL/min. Similarly, Al-P particles with an average size of 2.11 mm were obtained by Belščak-Cvitanović et al. (2015). The particles were formed using an Al-P solution with a 2.0 wt. % TGC and 80:20 alginate:pectin ratio utilizing a 5 mL syringe with a 0.337 mm nozzle size. In this experiment, using the peristaltic pump with the identical needle size, alginate:pectin ratio, and TGC, Al-P particles with a size of 2.03 mm were generated. The small difference in the particle size could be explained by the varied equipment (peristaltic vs. syringe pump) and curing solution (0.1 M CaCl₂) vs. ˜0.2 M CaCl₂)).

### Particle Size, Density, and Porosity of the Freeze-Dried Al-P Particles.

After comparing the Al-P bead formation techniques (i.e., the conventional vs. the system and method of extrusion-based 3D food printing), only the 3D-printed Al-P hydrogel particles were freeze-dried and characterized further since it was not expected to observe differences due to the bead production methods. However, the 3D-printed Al-P particles were characterized in detail due to the limited data (e.g., SEM, FTIR, and XRD data) on alginate and high methoxy pectin particles in the literature and in order to facilitate the potential applications of these particles in the food and pharmaceutical industries.

Freeze-drying was employed as a drying method to preserve the hydrogel structure and form relatively interconnected porous Al-P polymers. After freeze-drying, the generated Al-P particles were characterized for their size, density, and porosity (Table 5). All the particles were generated using a nozzle size of 0.159 mm. The sizes of the freeze-dried Al-P particles formed using TGCs of 1.8, 2.0, and 2.2 wt. % were 1.08, 1.18, and 1.27 mm, respectively. Compared to their sizes before freeze-drying (FIG. 11B), Al-P hydrogels with higher TGC resulted in less shrinkage. At higher TGC, more Al-P molecules were present in the same volumetric area, supporting the structure to minimize shrinkage during drying. This also led to a lower bulk density and a higher porosity at the TGC of 2.2 wt. % (Table 5), where the true density of the Al-P particles was measured as 1.86±0.02 g/cm³.

TABLE 5
Particle diameter, bulk density, and porosity of
freeze-dried Al—P particles.

| Total gum | Particle | Bulk | |
|---|---|---|---|
| concentration | diameter | density | Porosity |
| (wt. %) | (mm) | (g/cm³) | (%) |
| 1.8 | 1.08 ± 0.03^{a} | 0.09 ± 0.01^{a} | 95.1 ± 0.3^{b} |
| 2.0 | 1.18 ± 0.07^{a} | 0.06 ± 0.01^{b} | 96.7 ± 0.1^{a} |
| 2.2 | 1.27 ± 0.13^{a} | 0.06 ± 0.01^{b} | 97.2 ± 0.5^{a} |

*All the particles were formed using a 3D food printing system with a nozzle size of 0.159 mm at extrusion pressures of 25, 28, and 34 psi for TGC of 1.8, 2.0, and 2.2 wt. %, respectively. Data are given as means ± standard deviations. Values in the same column with different superscript letters are significantly different (p < 0.05).

Gelation of the Al-P solutions starts as the biopolymers come into contact with the CaCl₂) solution. The gelation starts from the surface of the droplet, and as CaCl₂) diffuses into the droplet, the biopolymers at the center of the droplet cross-links with Ca²⁺ ions. Therefore, since the diffusion of Ca²⁺ into the droplets generated with a lower TGC is faster owing to their lower viscosity (FIG. 10A), these droplets are expected to have a higher cross-linking density compared to that formed with a higher TGC. Consequently, the higher number of Ca²⁺ present in the structure of Al-P particles formed with a lower TGC may have also contributed to their increased density (Table 5). In general, high-porosity particles could be useful as microencapsulation carriers for bioactive compounds.

### Morphology of the Freeze-Dried Al-P Particles.

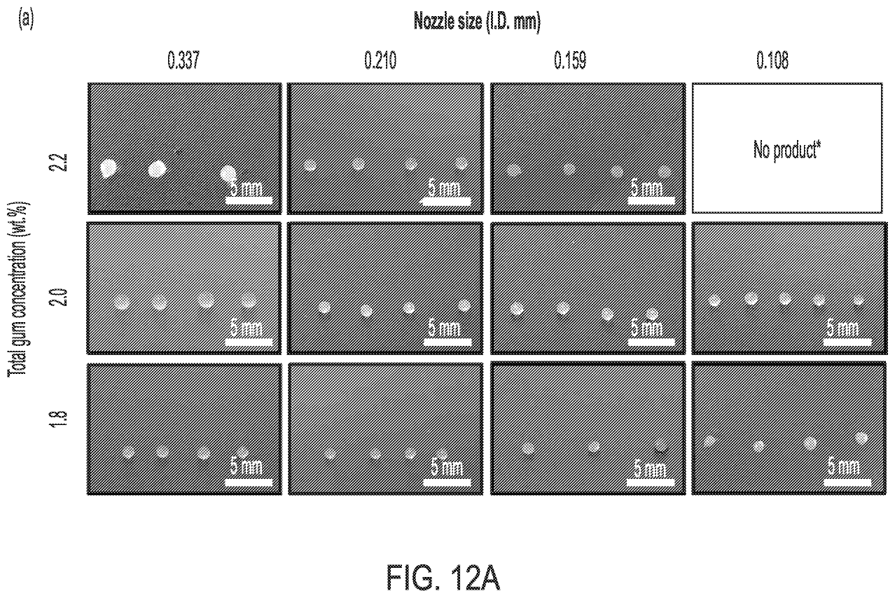

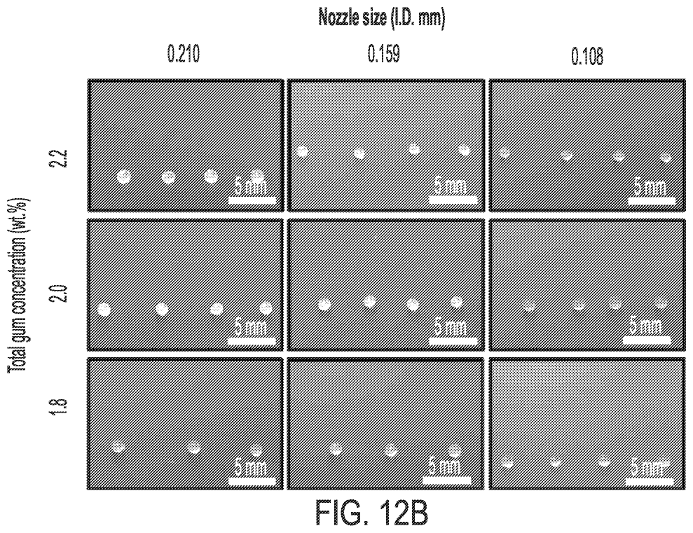

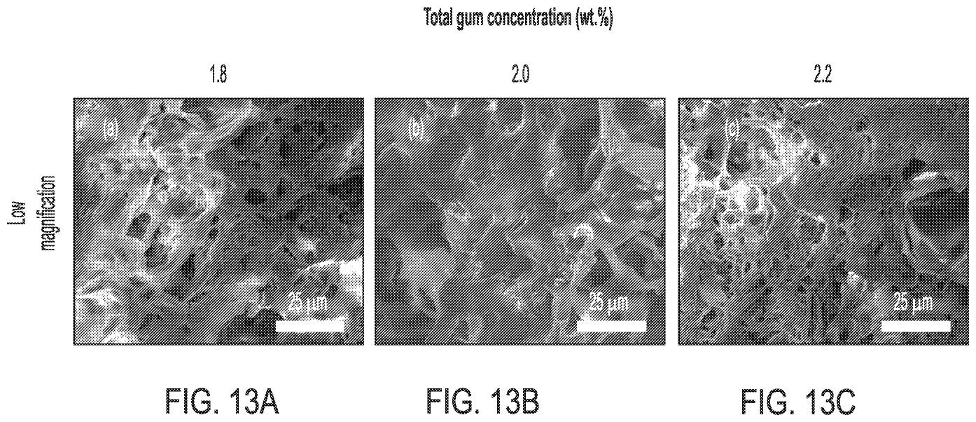

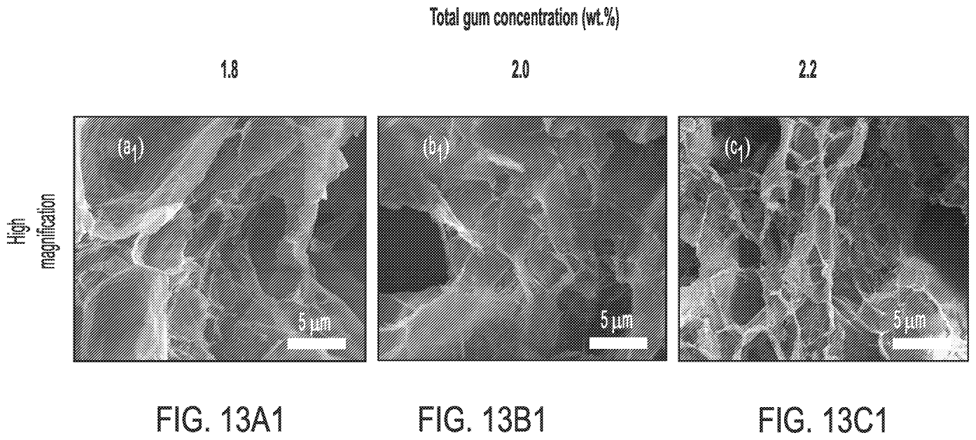

The morphology of the freeze-dried Al-P hydrogel particles at various TGCs was investigated using SEM (FIG. 13). All the samples showed a porous structure with irregular macropores where the pores were interconnected due to cross-linking of the polymers and ionic gelation.

In addition, the formation of ice crystals during freezing and then lyophilization of the beads also resulted in the generation of a macroporous structure. SEM images revealed that the morphology of the particles slightly differed depending on the TGC. As the TGC increased, a more porous structure was observed, which can be due to the less shrinkage and collapsing of the particles caused by ionic cross-linking and freeze-drying, respectively (FIG. 13A1, 13B1, 13C1). Also, at higher TGC, a denser hydrocolloid network structure increased gel stability against the growth of ice crystals. This result supports the density and porosity data obtained in this study (Table 5).

### X-Ray Diffraction.

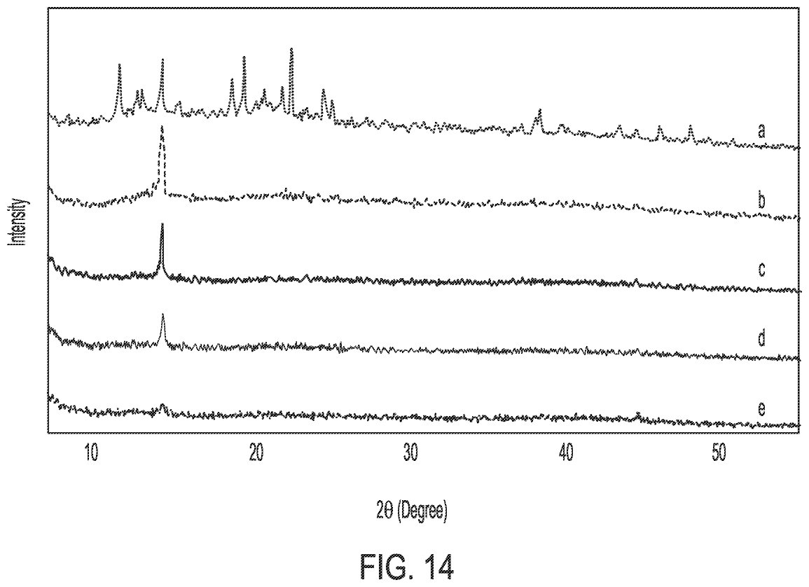

The X-ray diffraction patterns of the dried Al-P hydrogel particles with various TGC (i.e., 1.8, 2.0, and 2.2 wt. %), pure alginate, and pectin are depicted in FIG. 14. Pectin showed diffraction peaks at 2θ=11.65°, 13.05°, 14.25°, 18.8°, 19.50°, 22.50°, 24.75°, 38.4°, 46.1°, and 48.00°, respectively (FIG. 14A) while pure alginate exhibited a characteristic diffraction peak at 2θ=14.25° (FIG. 14B). Similar diffraction peaks have been reported for high-methoxyl pectin and alginate. Freeze-dried Al-P particles had a single clear diffraction peak at 2θ=14.25°, which was due to their alginate content and cross-linking with CaCl₂) and the resulting lateral packing among the molecules. Characteristic peaks of pectin were not observed in the XRD patterns of Al-P particles in part due to its relatively low concentration. Also, the presence of Ca²⁺ could have disrupted pectin's inter- and intramolecular interactions, resulting in reduced crystallinity. Similarly, the loss of crystallinity in the XRD patterns of the Al-P particles can be explained by the ionic interactions between biopolymers damaging the crystalline configuration. However, as the TGC increased, the intensity of the characteristic diffraction peak at 2θ=14.25° decreased (FIG. 14C, 14D, 14E). As described above, Al-P particles with a lower TGC are expected to have a higher cross-linking density, resulting in a more organized structure. Thus, the higher concentration of Ca²⁺ ions in the structure of Al-P particles formed with a lower TGC resulted in a higher peak intensity at 2θ=14.25°.

### Fourier Transform Infrared Spectroscopy.

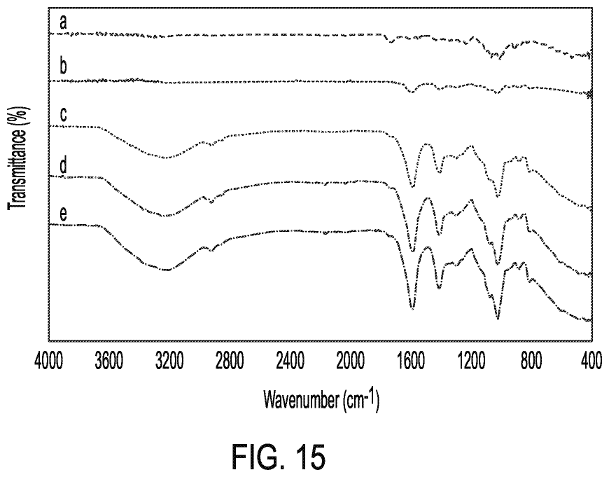

FIG. 15 depicts the ATR-FTIR spectra of pectin, alginate, and the freeze-dried Al-P particles with various TGC in the wavenumber range of 4000-400 cm⁻¹. The FTIR spectra demonstrate the characteristic absorption peaks of the utilized ingredients for the particle formation (FIGS. 15A, 15B) and the potential molecular interaction between alginate and pectin (FIGS. 15C, 15D, 15E). The FTIR spectra of pure alginate showed absorption bands at 1591 and 1420 cm⁻¹, which correspond to asymmetric and symmetric stretching vibrations of carboxylate salt ions, respectively, and are specific to ionic bonding. The absorption band related to C—O stretching was observed in the FTIR spectrum of pectin at the wavenumber of 1619 cm⁻¹. The addition of pectin caused the formation of a new peak in the FTIR spectra of Al-P particles (1732 cm⁻¹) attributed to the C—O stretching in the carboxyl group.

The FTIR spectra of the dried Al-P particles with different TGC (i.e., 1.8, 2.0, and 2.2 wt. %) were similar (FIGS. 15C, 15D, 15E). The absorption bands present in the FTIR spectra at 3700-3000 cm⁻¹ and 3000-2850 cm⁻¹ were attributed to O—H and C—H stretching vibrations, respectively. The absorption bands at 1076-1026 cm⁻¹ were associated with C—O—C antisymmetric stretch. Monosaccharide stretching was represented by the absorption bands in the 1200-800 cm⁻¹ range.

For Al-P particles (TGC: 1.8, 2.0, 2.2 wt. %), the carboxyl group characteristic peak at 1591 cm⁻¹ shifted to 1597, 1589, and 1589 cm⁻¹, respectively, suggesting the cross-linking of sodium alginate with Ca²⁺. Compared to pure alginate, Ca²⁺ cross-linking resulted in an increase in the stretching carboxyl group. Moreover, the shoulder that appeared at 1076 cm⁻¹ was ascribed to the C—C and C—O stretching, which can also be related to the presence of ionic cross-linking. Overall, it is well-studied that pectin and alginate are ionic polysaccharides, and they form hydrogels through chain-chain association, which is induced by the addition of divalent cations. As previously reported in the literature, the specific interactions of calcium ions with guluronate in alginate and galacturonate in pectin resulted in gel formation.

Finally, no chemical interactions were observed between alginate and pectin (FIG. 15). Specifically, the FTIR spectra of the Al-P particles did not show any covalent bonds between alginate and pectin since the absorption bonds wavenumbers of the carboxylic group of alginate and the carbonyl group of pectin remained unaltered.

As shown above, alginate-pectin hydrogel particles were successfully prepared by droplet extrusion using a 3D food printing system and method. The 3D food printing system and method can utilize various Al-P TGC, nozzle sizes, and extrusion pressures to create small particle sizes. The inventive 3D food printing system and method provide for smaller Al-P particles compared to the conventional method using a peristaltic pump when similar conditions were used.

The Al-P solutions have a shear-thinning behavior, where their viscosity, loss and storage moduli increase with increasing the TGC. Generally, increasing the TGC or decreasing the nozzle size will decrease the particle size. The smallest particle size (1.27 mm) can be achieved via the 3D food printing system and method at a TCG of 1.8 wt. % and a nozzle size of 0.108 mm. When the peristaltic pump is used, no particles are formed with the highest TGC (2.2 wt. %) and the smallest nozzle size (0.108 mm), confirming the limitations of the conventional method and its low flexibility in generating particles compared to the inventive 3D food printing system and method.

All freeze-dried Al-P particles have an interconnected porous structure. TGC affected the ionic cross-linking with Ca²⁺ ions and also the shrinkage rate upon freeze-drying. The crystallinity of the freeze-dried Al-P particles produced above reduced compared to that of pure alginate and pectin. However, the crystallinity is increased with the increased cross-linking density. FTIR spectra showed the ionic cross-linking with the Ca²⁺ ions; nevertheless, no chemical interaction between alginate and pectin was indicated, suggesting a physical entrapment of biopolymers. Overall, the inventive 3D food printing system and method can create Al-P particles with precise control over shape, size, and composition for developing delivery systems.

### Example 3: System and Process for Encapsulating Lutein in Dual-Layered Starch-Ethyl Cellulose Gels Using Three-Dimensional Food Printing

In this example, the parameters of the 3D printing process (i.e., nozzle diameter, printing temperature, printing pressure, layer height, and food-grade biopolymer concentration) were optimized for encapsulating lutein, a lipophilic bioactive compound, in a core EC solution with a starch paste outer layer. The effects of nozzle diameter, printing pressure, printing temperature, layer height, and lutein concentration on particle size, morphological, structural, and thermal properties of the freeze-dried hydrogel particles were investigated in the examples, along with structural integrity and printing accuracy and consistency in determining the optimum printing parameters. In addition, the structural properties and stability of lutein in the 3D-printed cyrogels were determined. The stability of lutein was also compared with crude lutein.

### Materials.

High amylose corn starch with 72% amylose content (CS-72) was received from Ingredion (IL, USA). Ethyl cellulose (with a viscosity of 18-22 mPa·s, 5% in toluene:ethanol (80:20) at 25° C.) was purchased from TCI (Tokyo, Japan). CS-72 and EC were utilized for 3D printing and lutein encapsulation without any additional treatment. Lutein with a purity of 10% was purchased from Botany Biosciences (CA, USA), which was then purified via ethanol extraction at 25° C. and used for the experiments. The lutein extraction was carried out for 1 hour at room temperature (23° C.) with agitation using 0.5 g of 10%-lutein powder and 10 mL of pure ethanol. Following the collection of the supernatant, the residue was extracted twice more with ethanol to obtain a decolorized residue. The collected supernatants were mixed and evaporated under nitrogen flow at 40° C. The dry extracts were kept under nitrogen at −80° C.

### Encapsulation of Lutein Via Coaxial 3D Printing

3D printing of the spiral cubes was performed using an extrusion-based Allevi 2 Bioprinter (Allevi, Inc., PA, USA) equipped with two (2) 10 mL extruders, a coaxial nozzle, and Bioprint Pro software (Allevi, Inc., PA, USA) (FIG. 1A). The coaxial system for co-extrusion had outer and inner nozzles of 1.2- and 0.7-mm diameters, respectively. CS-72 paste served as the coaxial nozzle's external material (i.e., shell matrix). The procedure described in Example 1 was used to prepare the starch paste. Briefly, four (4) concentrations of aqueous starch suspensions (9, 10, 11, and 12%, w/w) were first prepared. The samples were then heated in a Thermomix (Vorwerk, CA, USA) to 95° C. under a shear rate of 4260 rpm, sustained at this temperature for 25 min, and then immediately employed as inks for 3D food printing.

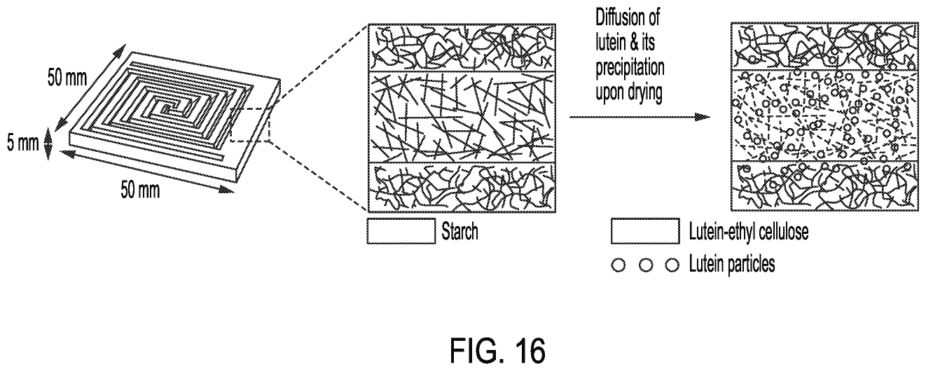

The core ink in the coaxial nozzle was formulated as an ethanol solution containing various EC concentrations (6, 8, and 10% w/v) and a specific quantity of lutein (20 mg/1 g of EC solution). EC was initially dissolved in ethanol for 1 h while being magnetically stirred at room temperature (23° C.). After adding 20 mg of lutein per 1 g of EC solution, the solution was stirred for an additional 15 min and was rested for 30 min at 4° C. before 3D printing. The extruder temperature of the core nozzle was held constant at 25° C. for EC-lutein solution to minimize lutein degradation. On the other hand, the temperature of the other extruder (i.e., creating the shell matrix) was set to 55, 65, or 75° C. for the starch paste during 3D printing. A 3D model (.stl format) with a spiral cube shape (height: 5 mm; length× width: 50×50 mm) was created using Tinkercad software (Autodesk Inc., CA, USA) (FIG. 16). The G-code was then developed from the .stl file using Bioprint Pro software and used for 3D printing. The layer height was optimized prior to sample preparation. Three (3) different layer heights (0.4, 0.7, and 1 mm) were investigated at the same printing conditions:starch (10%) and EC (10%) concentration, printing speed (4 mm/s), and printing temperature (55° C.). The samples were then printed using the optimized layer height.

The coaxial nozzle was used to deposit EC-lutein (inner flow) and starch paste (outer flow) at the same time. As shown in Table 6 below, the experimental design included three (3) printing parameters: the starch concentration, the EC concentration, and the printing temperature of the outer flow (starch paste). The printing pressure of the outer flow (starch paste) was adjusted (between 40-50 psi) in accordance with the temperature and starch concentration, while the inner flow (EC-lutein) printing pressure was modified (between 1-3 psi) based on the EC concentration. The samples were printed on a plastic Petri dish as the bed surface and stored at 4° C. in a sealed container for 48 h and then lyophilized in a freeze dryer (VirTis benchtop SLC, PA, USA) at −108° C. and 0.015 kPa for 48 h. The dried samples were kept at −80° C. in a sealed container prior to further characterization. The 3D-printed samples, produced with CS-72, EC, and lutein, were hereafter labeled as S-C/EC-C (T° C.), where “C” indicates the concentration of starch(S) and EC, and “T° C.” shows the printing temperature of starch paste. Control samples were printed without a core, and the lutein content in the other samples was maintained constant at a value of 20 mg/g EC solution.

TABLE 6
The 3D food printing parameters.

| | | Starch (S) | EC | Printing |
|---|---|---|---|---|
| Sample | Sample | concentration | concentration | temperature |
| number | label | (%) | (%) | (° C.) (outer flow) |
| 1* | S-9/EC-0 | 9 | 0 | 55 |
| | (55° C.) | | | |
| 2* | S-10/EC-0 | 10 | 0 | 65 |
| | (65° C.) | | | |
| 3* | S-11/EC-0 | 11 | 0 | 65 |
| | (65° C.) | | | |
| 4 | S-9/EC-10 | 9 | 10 | 75 |
| | (75° C.) | | | |
| 5 | S-9/EC-10 | 9 | 10 | 65 |
| | (65° C.) | | | |
| 6 | S-9/EC-10 | 9 | 10 | 55 |
| | (55° C.) | | | |
| 7 | S-10/EC-10 | 10 | 10 | 75 |
| | (75° C.) | | | |
| 8 | S-10/EC-10 | 10 | 10 | 65 |
| | (65° C.) | | | |
| 9 | S-10/EC-10 | 10 | 10 | 55 |
| | (55° C.) | | | |
| 10 | S-11/EC-10 | 11 | 10 | 75 |
| | (75° C.) | | | |
| 11 | S-11/EC-10 | 11 | 10 | 65 |
| | (65° C.) | | | |
| 12 | S-11/EC-10 | 11 | 10 | 55 |
| | (55° C.) | | | |
| 13 | S-11/EC-8 | 11 | 8 | 65 |
| | (65° C.) | | | |
| 14 | S-11/EC-6 | 11 | 6 | 65 |
| | (65° C.) | | | |
| 15 | S-12/EC-10 | 12 | 10 | 65 |
| | (65° C.) | | | |

*Control samples were printed without lutein. Lutein content in samples 4 to 15 was 20 mg/g EC solution.

### Micro-CT and Image Analysis.

Spiral cubes with the dimensions of 10 mm height, 15 mm length, and 15 mm width were 3D-printed using the formulation of S-10/EC-10 (55° C.) at three different layer heights (i.e., 0.4, 0.7, and 1 mm), and the samples were then characterized using a Nikon X TH 225 ST (Nikon, NY, USA) to visualize the 3D microstructure of the printed spiral cubes. X-ray computed tomography (CT) imaging was performed on three representative 3D-printed samples with various layer heights. The samples were scanned as a whole without any modifications. The settings for the micro-CT were 165 kV source voltage and 88 μA source current. The pixel image resolution during scanning was 19.08 μm. A frame averaging of four with the Minimize Ring Artifact setting on was used to acquire a stack of 2000 by 2000-pixel radiography images. These were then reconstructed to provide a TIFF stack of images. Materials within the 3D-printed samples were detected as the higher density material, lower density material, and air.

### Macroscopic and Microstructural Observations.

The printing accuracy was determined by comparing the images captured after 3D printing and the digital 3D geometry. The scale bar in the photographs was established using a ruler as a reference.

The 3D-printed products' microstructure was examined using an FEI NovaNanolab200 Dual-Beam system equipped with a 30 kV SEM FEG column and a 30 kV FIB column (FEI Company, OR, USA). The specimens were prepared by cutting thin cross-sections from the freeze-dried 3D-printed samples. The specimens were then placed on top of conductive carbon tape on aluminum stubs. The specimens were then prepared for imaging by coating them with a gold layer using a sputter-coater (EMITECH SC7620 Sputter Coater, MA, USA). Finally, SEM imaging was carried out at an acceleration voltage of 15 kV and a current of 10 mA.

### Storage Stability of Lutein.

Three (3) freeze-dried 3D-printed samples with the highest shape accuracy were selected and stored in the dark in open glass vials (5 g of each) at 25 and 50° C. with 30% relative humidity (RH) for 21 days. The crude lutein, obtained through ethanol extraction, and mixed with starch and EC, was also kept under the same conditions as a control. Samples were characterized for their lutein content at time intervals of 0, 2, 4, 6, 8, 10, 14, and 21 days. The samples were mixed with 4 mL of DI water and vortexed for 2 min at 3000 rpm. Then, 1 mL of acetone, 1 mL of ethanol, and 3 mL of hexane were added to the mixture and vortexed for another 2 min at 3000 rpm. After centrifuging the prepared mixture at 3000 rpm for 10 min at 4° C., the hexane phase was transferred to a glass amber vial. After removing the hexane under nitrogen flow, 2 mL of ethanol was added. The concentration of lutein was determined by a UV-Vis spectrophotometer (Milton Roy Spectronic 1201, PA, USA) at 445 nm, using a created standard curve (0.0078-1.78 mg/mL-R²=0.998). The experiments were carried out in triplicates.

### Degradation Kinetics.

The lutein degradation rate was calculated using Equation 3 below:

$$d [ C ] / dt = {k [ C ]}^{n} \qquad ( Equation 3 )$$

where C is lutein concentration (%), k is the reaction rate constant, and n is the order of the reaction. The correlation coefficient (R²) was used to determine which kinetic model best describes the data on lutein degradation. Lutein degradation as a function of temperature and time followed second-order kinetics as defined by Equation 4 below:

$$( 1 / [ C ] = 1 / [ C 0 ] + kt ) \qquad ( Equation 4 )$$

where C is the lutein content (%) at time t, CO is the lutein content at to, tis the time (days), and k is the reaction rate calculated from the slope of linear regressions.

### Statistical Analysis.

SPSS Statistics software was used to perform ANOVA followed by LSD's comparison test at a significance level of 0.05. All experiments were carried out in triplicates. For the measured parameters, the means of three replications were reported, along with their standard deviations.

### Effect of Layer Height on Coaxial Printing.

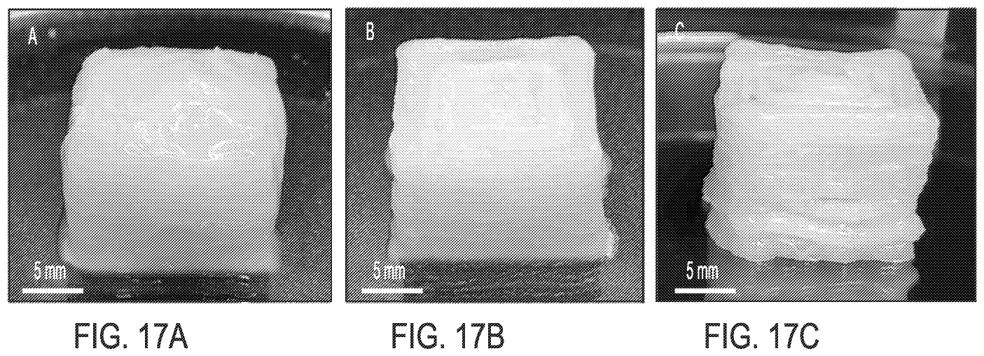

3D prints with accurate shapes and the absence of any internal or external flaws are critical quality requirements for 3D printing. Along with the material used, the 3D printing settings dictate the build quality. FIG. 17 is photograph images (FIGS. 3A, 3B, and 3C) and microCT images (FIGS. 3A1, 3B1, and 3C1) of 3D-printed samples with different layer heights. Because microCT imaging was performed to compare the effect of layer height on the microstructure of the printed objects, a 3D geometry with a spiral cube shape was used, where the model's height was increased from 5 to 10 mm to increase the number of layers better displaying the effect of layer height. The length and width of the model were also reduced from 50 mm to 15 mm. Pictures of the printed objects were used to investigate the external flaws of the printed products (FIG. 17), which showed how accurately the layers were superimposed. The 3D print was considered successful when the layers appeared uniformly straight and aligned layer by layer. For instance, this was observed for the sample S-10/EC-10 (55° C.) printed at 0.7 mm layer height.

Layer height is a key variable in obtaining superior form accuracy and minimal defects. Setting the layer height too low could result in an accumulation due to the material being deposited on top of the layers. This could lead to layer overlapping and deformation of the product. Setting a layer height too high, on the other hand, could result in a shortage of material being deposited per layer, which could result in interior cavities. In order to determine the proper layer height, the product volume was compared to the .stl file volume in terms of the visual aspect. Samples with volumes lower or higher than the .stl volume had low build quality (an uneven top surface, internal cavities, or layer overlapping). The layer heights used to print our samples were 0.4, 0.7, and 1 mm. A change in sample volume dimensions can also be caused by syneresis, which is the release of water from the starch gel because of increased crosslinking caused by ethanol. The coaxial printing of EC-lutein ink exacerbated syneresis (FIG. 17). This caused the object to shrink after printing and increased the defects caused by layer height. As a result, the volume of the samples was calculated immediately after printing to identify the layer height-related defects. The .stl file's volume was 2.25 cm³, and the samples' volumes were 2.55±0.24, 2.40±0.16, and 3.32±0.35 cm³ for the layer heights of 0.4, 0.7, and 1 mm, respectively. It was noted that the printed objects, specifically at 0.4 and 1 mm, had volumes that were higher than those specified by .stl files, which led to poor build quality. Setting the layer height to a constant value of 0.7 mm provided the best printing quality with the least defects since the products' cubic geometry was retained, and the layers were properly superimposed (FIGS. 3B, 3B1). Slight differences were observed between the lutein-containing and empty control samples (data not shown). As previously explained, structural defects may emerge in two different ways. Internal cavities, as the first type of imperfection, were visualized from the processing of microCT images. Compared to the other samples, the ones printed at a higher layer height (1 mm) revealed more interior voids (FIG. 17C1). The rough and asymmetrical edge of the product was another type of defect that was observed for the samples prepared at a lower layer height (0.4 mm) (FIG. 17A). The cross-section area of this sample revealed irregular and asymmetrical edges (FIG. 17A1). Therefore, the samples used to investigate the storage stability of lutein were printed with the optimized layer height of 0.7 mm.

### Effects of Starch, EC Concentration, and Printing Temperature on Coaxial Printing.

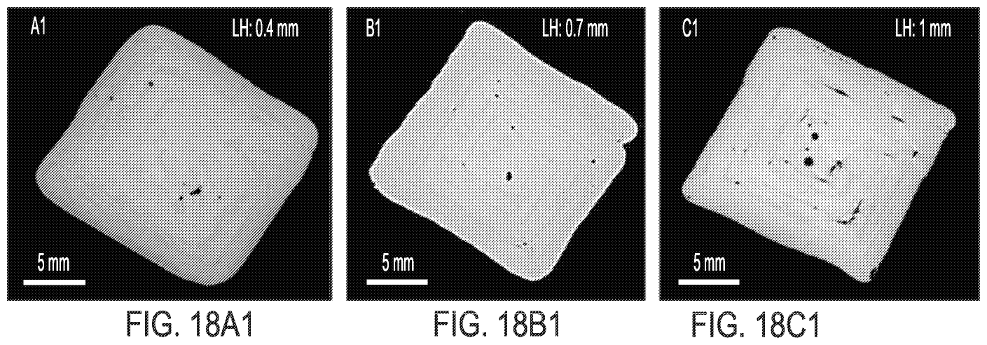

FIGS. 18A through 18R depict images of 3D-printed objects as a function of starch and EC concentrations and printing temperature. The inner flow (EC-lutein) was extruded smoothly inside the coaxial nozzle. The starch gel provided adequate printing performance, as seen by the high resolution and shape retention of the shell matrix printed without EC-lutein. When using 10 and 11% starch concentrations, EC-lutein encased in a thick shell made of starch gel displayed a high degree of shape retention. Conversely, the starch paste extruded through the external nozzle had a low mechanical strength when 9% starch was used, and the product was deformed while printing. This observation demonstrated the importance of the shell matrix strength, which was formed during coaxial 3D printing. The dimensional stability was enhanced for the 10% starch, and layers stacked well throughout the printing process, but lutein was still somewhat leaked while printing at 75° C. Shape fidelity increased for 10% starch at 65 and 55° C., and no lutein leakage was observed at 55° C. (FIG. 18). When the starch concentration was increased to 11%, the starch paste had enough mechanical strength to support the shape at the printing temperature of 75° C.; however, at lower temperatures (55 and 65° C.), the starch paste's more solid-like structure prevented the distribution of EC-lutein evenly in the matrix, as evidenced by the yellow spots that were observed after printing. At the same temperature (75° C.), the deformation of the products could be seen obviously when 12% starch concentration was utilized. Extra starch resulted in the formation of a strong gel, which reduced the ability to keep EC-lutein evenly inside. The use of 10% starch at 55° C., therefore, provided the best performance (i.e., dimensional stability) for the coaxial printing system because it demonstrated appropriate resolution, which better matched the 3D model, and entrapped EC-lutein evenly in the core. Although the shape fidelity was higher at 65° C. compared to 75° C. when using 11% starch, EC-lutein was not evenly covered in the core, which we assumed would be improved by reducing the EC concentration. Therefore, the effect of EC concentration on shape fidelity and encapsulation was also investigated using a constant starch concentration of 11% at 65° C. It was observed that lower EC concentrations (8 and 6%) prevented EC-lutein accumulation during the printing and increased the uniformity of the printed object due to the smoother flow of EC-lutein at lower EC concentrations, which improved printing performance when 11% starch was used as the outer flow. Between 8 and 6% EC, however, there was no significant difference.

### Microstructural Properties.

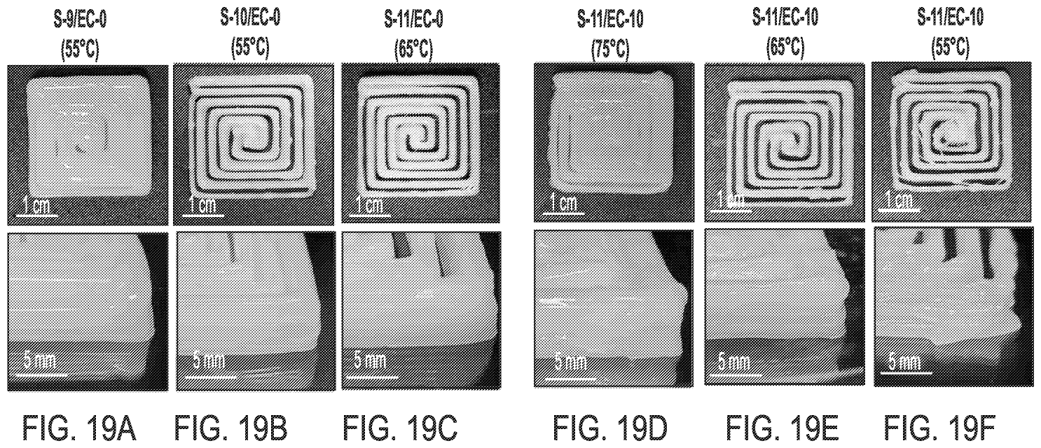

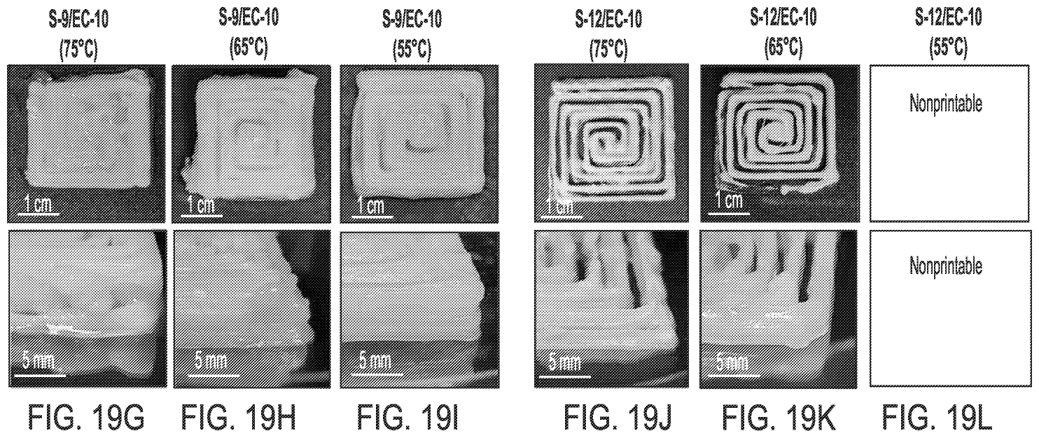

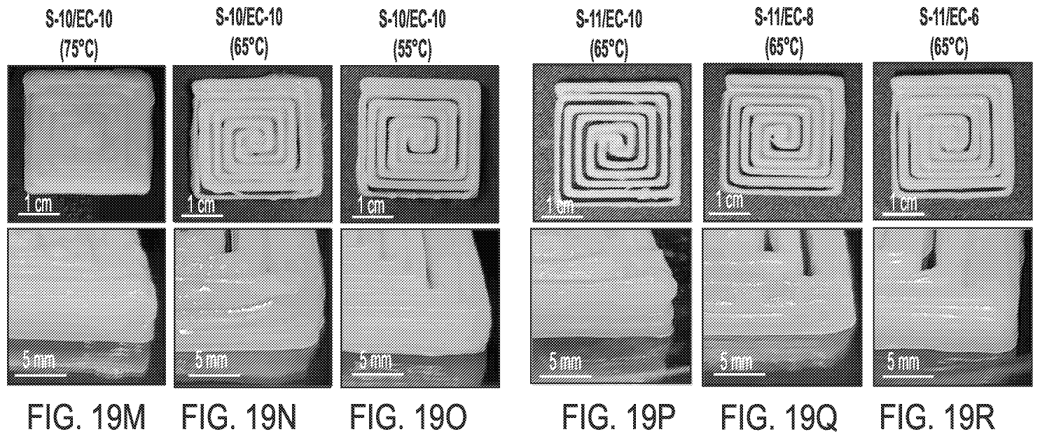

FIGS. 19A through 19G are SEM images of the samples that were 3D-printed with (S-10/EC-10 (55° C.)) or without (S-10/EC-0 (55° C.)) lutein entrapment. It was clear from the cross-sectional structure of the samples that the EC-lutein was deposited between two starch layers (FIGS. 19A, 19B). Corn starches with (FIGS. 19C1, 19C2) and without lutein entrapment (FIG. 19F) have different morphological properties, confirming that lutein encapsulation had an effect on the morphology of gelatinized starch. A porous structure was observed for the control sample as starch retrogradation involved molecular rearrangements and associations, producing a compact, highly organized structure. SEM images revealed that when lutein was added to the corn starch network, the microstructure became more uneven than in the control sample, and a less porous matrix with particles embedded in the network was observed for the starch incorporated with lutein. This observation might be due to the addition of a lipophilic compound, lutein, to a hydrophilic polymer network, starch, which might have altered the interactions between the chains of the polymer matrix, causing non-uniformity in the structure. Moreover, starch is dehydrated by ethanol, which can entangle and coagulate starch chains.

FIGS. 19C1 and 19C2 depict larger openings on the fractured surface of the 3D-printed sample containing EC and lutein. On the other hand, the control sample had a porous and more homogeneous structure with a higher density of small openings (FIG. 19F). There was also a difference in the starch microstructure from the edge (FIG. 19D) to the core (FIGS. 19C1, 19C2). As starch retrograded, water was released, which could mix with the ethanol migrating from the core to the edge and reducing the concentration of ethanol, thereby reducing the migration of lutein with ethanol to the edge. This led to a more homogeneous and porous structure in the edge section. As a result, there was no lutein release during the starch retrogradation step, and the lutein was encapsulated in the areas closer to the core. Overall, the SEM images confirmed that despite its lipophilicity, lutein could be encapsulated into the pores of the starch 3D structure following deposition and via ethanol diffusion into the starch paste.

As previously explained, EC was added to the internal flow to make the solution viscous to prevent lutein from leaking out of the printed sample while having better control over the 3D printing process. This increased the retention of the lutein inside the printed sample because it formed an ethanol-based gel when exposed to the aqueous starch paste. Water had a clear impact on the creation of the microstructure of EC, as shown by the SEM image of pure-EC (FIG. 19G). When pure EC solution was exposed to the water as a nonsolvent, EC solidified and became opaque (image not shown). The SEM image of coagulated pure EC revealed a structure having asymmetrical pores in shape and size. However, when the EC solution was extruded as the internal fluid, the EC structure was more compact than the pure EC (FIGS. 19E1, 19E2). This difference can be explained by the coagulation rate of the EC solution extruded into the starch paste. When water was added to the EC/ethanol solution, porous and spongy EC-based films were produced, indicating that phase separation occurred. As the solubility of EC increased with increasing the temperature, when the EC/ethanol solution was exposed to starch paste at high temperatures, the interactions between ethanol and EC strengthened, which probably reduced the phase separation, enabling EC to diffuse into the starch matrix.

### Storage Stability of Lutein.

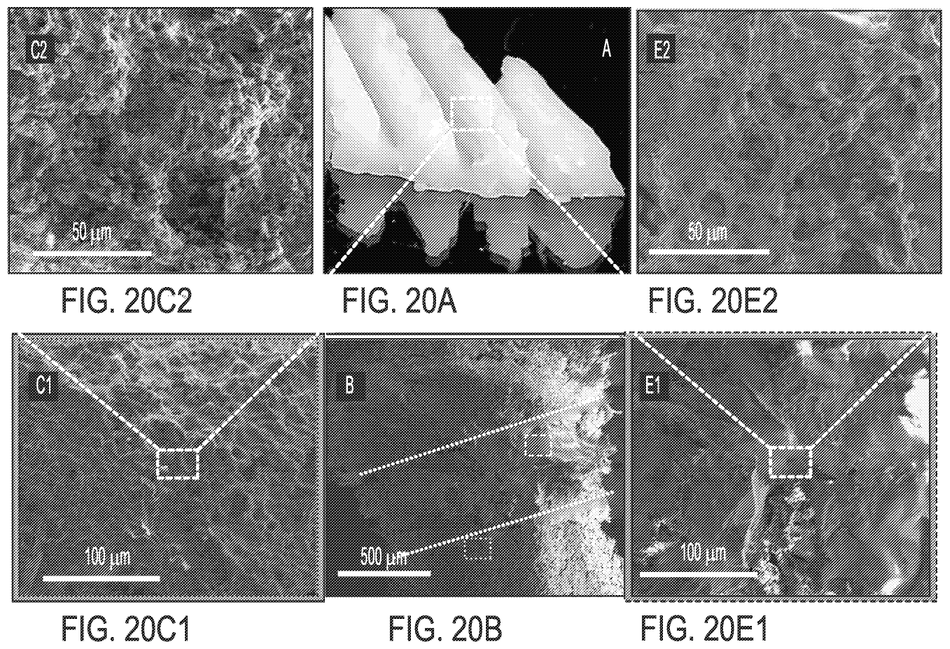

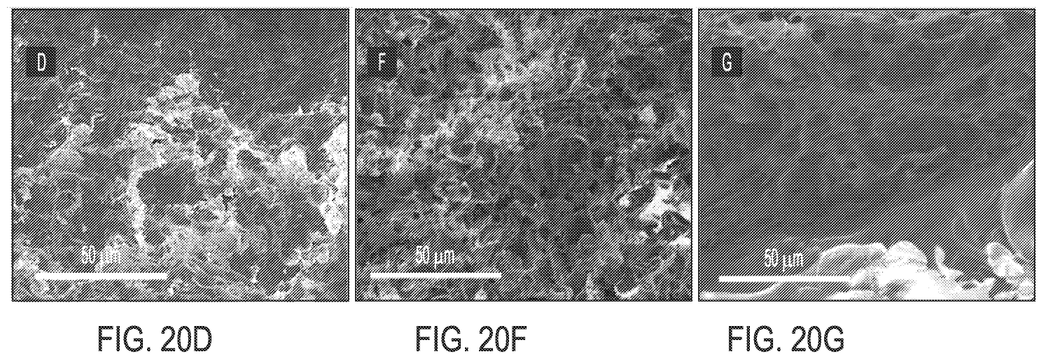

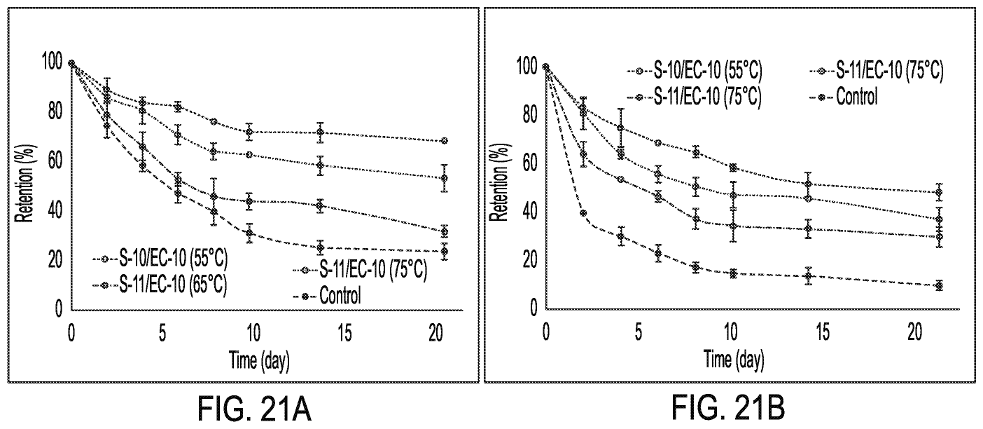

Lutein is more prone to degradation than other carotenoids due to its heat-sensitive hydroxyl groups and conjugated double bonds. Therefore, its stability during storage at 25 and 50° C. up to 21 days at RH of 30% was assessed using the three best formulations (S-10/EC-10 (55° C.); S-11/E-10 (65° C.); and S-11/EC-10 (75° C.)) and the control sample, a physical mixture of starch, EC, and lutein (FIGS. 20A and 20B). This analysis aimed to determine the effectiveness of the developed 3D printing encapsulation method in reducing lutein's chemical degradation.

As a result of lutein's high susceptibility to oxygen and temperature, the retention of both unencapsulated and encapsulated lutein dropped with storage time (21 days). However, the retention of encapsulated lutein was significantly higher than that of unencapsulated lutein (p<0.05). Specifically, the retention of encapsulated lutein incubated at 25° C. was ˜70% after 21 days, while the unencapsulated physical mixture of crude lutein was only 24% (FIGS. 20A and 20B).

In addition, encapsulation of lutein via dual-layered 3D printing resulted in lutein degradation of only ˜17% when stored at 50° C. for 2 days. On the other hand, about 61% of the lutein in the physical mixture was degraded under the same storage conditions. When lutein was loaded into a 10% starch paste as the outer layer at 55° C., only 30% of the encapsulated lutein was degraded after 21 days of storage at 25° C., as opposed to the unencapsulated lutein, ˜76% of which was degraded at the same time. Similar trends were observed for both encapsulated and control lutein at 50° C., but with higher degrees of degradation. After storage at 50° C. for 21 days, encapsulated lutein (S-10/EC-10 (55° C.)) and the physical mixture of crude lutein samples retained ˜48% and 10% of their initial lutein content, respectively, confirming that encapsulation via 3D printing significantly improved the retention of lutein. Overall, loading lutein in starch/EC structures via 3D printing significantly improved lutein stability even at higher temperatures without the need for extra separation and purification steps.

The degradation profiles of encapsulated and control crude lutein followed second-order kinetics with significant differences in their degradation rate constant (k) values: 0.0002 and 0.0017, respectively (p<0.05; Table 7). S-10/EC-10 (55° C.) and S-11/EC-10 (75° C.) samples showed the lowest degradation rate constants of 0.0002, 0.0004 at 25° C., and 0.00002, 0.00003 at 50° C., respectively (Table 7). When comparing the shapes of these samples, the shape accuracy of the printed products had a noticeable impact on the degradation rate of the lutein encapsulated in the starch/EC structure (FIG. 20). The improved stability of lutein was evidenced by their higher shape accuracy.

TABLE 7
Model fitting for lutein degradation in 3D-printed
samples and crude lutein

| | k | | R² | |
|---|---|---|---|---|
| Samples | 25° C. | 50° C. | 25° C. | 50° C. |
| S-10/EC-10 | 0.0002 ± | 0.00002 ± | 0.87 ± | 0.95 ± |
| (55° C.) | 0^{c} | 0^{b} | 0.04^{b} | 0.01^{ab} |
| S-11/EC-10 | 0.0004 ± | 0.00003 ± | 0.92 ± | 0.93 ± |
| (75° C.) | 0.0001^{c} | 0.00001^{b} | 0.05^{ab} | 0.01^{b} |
| S-11/EC-10 | 0.001 ± | 0.00005 ± | 0.95 ± | 0.86 ± |
| (65° C.) | 0.0001^{b} | 0.00001^{b} | 0.02^{a} | 0.01^{c} |
| Control crude | 0.0017 ± | 0.0043 ± | 0.93 ± | 0.96 ± |
| lutein | 0.0003^{a} | 0.0011^{a} | 0.01^{a} | 0.03^{a} |

*Means in the same column with different superscript letters are significantly different (p < 0.05).

The benefits and advantages described above may relate to one embodiment or may relate to several embodiments. The embodiments are not limited to those that solve any or all of the stated problems or those that have any or all of the stated benefits and advantages. The operations of the methods described herein may be carried out in any suitable order or simultaneously where appropriate. Additionally, individual blocks may be added or deleted from any of the methods without departing from the spirit and scope of the subject matter described herein. Aspects of any of the examples described above may be combined with aspects of any of the other examples described to form further examples without losing the effect sought.

The above description is given by way of example only, and various modifications may be made by those skilled in the art. The above specification, examples, and data provide a complete description of the structure and use of exemplary embodiments. Although various embodiments have been described above with a certain degree of particularity or with reference to one or more individual embodiments, those skilled in the art could make numerous alterations to the disclosed embodiments without departing from the spirit or scope of this specification.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises,” “comprising,” or any other variations thereof are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

For purposes of the instant disclosure, the term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

The preceding detailed description of exemplary embodiments of the invention makes reference to the accompanying drawings, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. For example, the steps recited in any of the method or process claims may be executed in any order and are not limited to the order presented. Thus, the preceding detailed description is presented for purposes of illustration only and not of limitation, and the scope of the invention is defined by the preceding description and with respect to the attached claims.

1. A method for fabricating a porous hydrogel, the method comprising the steps of:
preparing a bio-ink composition comprising a predetermined concentration of a food-grade biopolymer; and
extruding the bio-ink composition from a three-dimensional food printing system to form the porous hydrogel.

2. The method of claim 1 wherein the food-grade biopolymer comprises starch, alginate, pectin, chitosan, cellulose, agarose, guar gum, agar, carrageenan, gelatin, dextran, xanthan, or a combination or mixture thereof.

3. The method of claim 2 wherein the extruding step further comprises extruding the bio-ink composition from the three-dimensional food printing system at a printing temperature of between about 23° C. to about 95° C. to form the porous hydrogel.

4. The method of claim 3 wherein the printing temperature is between about 23° C. to about 25° C.

5. The method of claim 3 wherein the printing temperature is between about 55° C. to about 95° C.

6. The method of claim 2 wherein the extruding step further comprises extruding the bio-ink composition from the three-dimensional food printing system at a printing height of between about 0.4 mm to about 5 mm to form the porous hydrogel.

7. The method of claim 6 wherein the printing height is about 2.5 cm.

8. The method of claim 2 wherein the extruding step further comprises extruding the bio-ink composition from the three-dimensional food printing system at a printing speed of between about 4 mm/s to about 6 mm/s to form the porous hydrogel.

9. The method of claim 8 wherein the printing speed is about 6 mm/s.

10. The method of claim 2 wherein the extruding step further comprises extruding the bio-ink composition from the three-dimensional food printing system at a pneumatic pressure of between about 1 psi and about 120 psi to form the porous hydrogel.

11. The method of claim 10 wherein the pneumatic pressure is between about 4 psi and about 25 psi.

12. The method of claim 2 wherein the extruding step further comprises extruding the bio-ink composition from the three-dimensional food printing system from a nozzle having a predetermined diameter to form the porous hydrogel.

13. The method of claim 12 wherein the diameter is between about 0.08 mm to about 1.2 mm.

14. The method of claim 13 wherein the diameter is between about 0.08 mm and about 0.33 mm.

15. The method of claim 13 wherein the diameter is between about 0.108 mm and about 0.210 mm.

16. The method of claim 13 wherein the diameter is between about 0.7 mm and about 1.2 mm.

17. The method of claim 16 wherein the nozzle further comprises:
a shell matrix solution extruder having a diameter of about 1.2 mm; and
a core solution extruder having a diameter of about 0.7 mm.

18. The method of claim 1 further comprises the step of freeze-drying the porous hydrogel at a temperature of about −80° C.

19. The method of claim 19 further comprises the step of lyophilizing the porous hydrogel at a condenser temperature of about −108° C. under a vacuum pressure of about 0.015 kPa.

20. The method of claim 1 wherein the step of preparing the bio-ink composition further comprises the step of preparing an aqueous biopolymer suspension or solution having the predetermined concentration of the biopolymer.

21. The method of claim 20 wherein the biopolymer is high amylose corn starch having a concentration between about 10% w/w and about 15% w/w.

22. The method of claim 21 wherein the concentration of high amylose corn starch is about 15% w/w.

23. The method of claim 20 further comprises the step of heating the biopolymer suspension under high shear conditions.

24. The method of claim 23 wherein the heating step further comprises heating the biopolymer suspension to about 95° C. for about 20 minutes under high shear conditions of about 4260 rpm.

25. The method of claim 20 wherein the step of preparing the bio-ink composition further comprises preparing an aqueous alginate-pectin solution having an alginate-pectin ratio of about 80:20.

26. The method of claim 25 wherein the alginate-pectin solution comprises a total gum concentration of between about 1.8 wt. % and about 2.2 wt. %.

27. The method of claim 25 wherein the extruding step further comprises extruding the bio-ink composition from the three-dimensional food printing system into a calcium chloride solution to form the porous hydrogel.

28. The method of claim 27 wherein the calcium chloride solution has a concentration of about 0.1 M.

29. The method of claim 1 wherein the method further comprises the step of encapsulating a bioactive compound, a nutraceutical, a micronutrient, a probiotic, or a combination or mixture thereof in the porous hydrogel.

30. The method of claim 1 wherein the method further comprises the steps of:
preparing a core bio-ink solution comprising at least a bioactive compound;
preparing a shell matrix bio-ink solution comprising a food-grade biopolymer; and
extruding the core bio-ink solution and the shell matrix bio-ink solution from a coaxial extrusion nozzle of the three-dimensional food printing system to form the hydrogel encapsulated with the bioactive compound.

31. The method of claim 30 wherein the bioactive compound is a nutraceutical, a micronutrient, a probiotic, or a combination or mixture thereof.

32. The method of claim 31 wherein the step of preparing the core solution further comprises the steps of:
preparing a solvent solution comprising a predetermined concentration of a core polymeric material;
adding a predetermined amount of the bioactive compound to the polymeric material solvent solution; and
stirring the bioactive compound-polymeric material solvent solution for about 15 minutes and then resting for about 30 minutes at about 4° C. to form the core bio-ink solution.

33. The method of claim 32 wherein the concentration of the polymeric material is between about 6% to about 10% w/v.

34. The method of claim 33 wherein the concentration of the polymeric material is about 10% w/v.

35. The method of claim 32 wherein the amount of the bioactive compound is about 20 mg/1 g of the bioactive compound.

36. The method of claim 35 wherein the bio-ink composition further comprises:
ethyl cellulose between about 6% to about 10% w/v;
lutein about 20 mg/1 g of ethyl-cellulose; and
corn starch between about 9% and about 12% w/w.

37. The method of claim 36 wherein the bio-ink composition further comprises:
ethyl cellulose about 10% w/v;
lutein about 20 mg/1 g of ethyl-cellulose; and
corn starch between about 10% and about 11% w/w.

38. The method of claim 32 wherein the extruding step further comprises the step of:
coaxially extruding the core bio-ink solution at a temperature of about 25° C. and the shell matrix bio-ink solution at an extrusion temperature between about 55° C. to about 75° C. from the coaxial nozzle of the three-dimensional food printing system.

39. The method of claim 38 wherein the extrusion temperature is between about 55° C. to about 65° C.

40. The method of claim 32 wherein the extruding step further comprises the step of:
coaxially extruding the core bio-ink solution at a pressure between about 1 and about 3 psi and the shell matrix bio-ink solution at a pressure between about 40 and 50 psi from the coaxial nozzle of the three-dimensional food printing system.

41. The method of claim 32 wherein the method further comprises the step of:
freeze-drying the hydrogel encapsulated with the bioactive compound at a predetermined freeze-drying temperature to form a dual-layered cryogel encapsulated with the bioactive compound.

42. The method of claim 41 wherein the freeze-drying temperature is about −80° C.

43. The method of claim 41 further comprises the step of lyophilizing the hydrogel encapsulated with the bioactive compound at a condenser temperature of about −108° C. under a vacuum pressure of about 0.015 kPa.

44. A porous hydrogel fabricated from the process of claim 1.

45. A targeted delivery system comprising a hydrogel encapsulated with a bioactive compound, a nutraceutical, a micronutrient, a probiotic, or a combination or mixture thereof fabricated from the process of claim 1.
